(19) United States
(12) Patent Application Publication
(10) Pub. No.: US 2021/0080371 A1
(43) Pub. Date: Mar. 18, 2021

(54) COMPUTER SYSTEM AND METHOD FOR PREDICTING PETROPHYSICAL PROPERTIES IN A FLUID HAVING ONE OR MORE PHASES IN POROUS MEDIA

(71) Applicant: The Penn State Research Foundation, University Park, PA (US)

(72) Inventors: Russell T. JOHNS, University, PA (US); Saeid KHORSANDI, University Park, PA (US); Liwei LI, University Park, PA (US)

(73) Assignee: The Penn State Research Foundation, University Park, PA (US)

(21) Appl. No.: 16/971,558

(22) PCT Filed: Feb. 20, 2019
(86) PCT No.: PCT/US2019/018659

§ 371 Date: Aug. 20, 2020

Related U.S. Application Data
(60) Provisional application No. 62/632,759, filed on Feb. 20, 2018.

(51) Int. Cl. G01N 15/08; G01V 99/00

(52) U.S. Cl. CPC G01N 15/0806; G01V 99/005

(57) ABSTRACT

A compositional simulator that is fully compositional and more robust and accurate is disclosed. Relative permeability (kr) and capillary pressure (Pc) are modeled as state functions, making them unique for a given set of inputs, which can include Euler characteristic, wettability, pore connectivity, saturation, and capillary number. All of these are made to be a function of composition, T, and P or rock properties. These state function kr-Pc models are fully compositional and can fit experimental data, including complex processes such as hysteresis. The models can be tuned to measured relative permeability data, and then give consistent predictions away from that measured data set. Phase labeling problems are eliminated. Flux calculations from one grid block to another are based on phase compositions. Simulations for three or four-phase hydrocarbon phases are possible. Time-step sizes increase to stability limits of implicit-explicit methods. Fully implicit methods are possible and significant improvements are expected.

### CROSS-REFERENCE TO RELATED APPLICATION

This application claims the benefit of U.S. Provisional Application No. 62/632,759 filed 20 Feb. 2018, the entire disclosure of which is hereby incorporated by reference herein.

### TECHNICAL FIELD

The present disclosure relates to a compositional simulator for recovery predictions that are fully compositional, more robust and accurate and that incorporate relative permeability and capillary pressure state functions.

### BACKGROUND

Commercial compositional simulators commonly apply correlations or empirical relations based on tuned experimental data to calculate phase relative permeabilities. These relations cannot adequately capture effects of hysteresis, fluid compositional variations and rock wettability alteration. Furthermore, these relations require phases to be labeled, which is not reliable or accurate for complex miscible or near miscible displacements with multiple hydrocarbon phases. Therefore, these relations that require phase labeling can be discontinuous for miscible and near-miscible displacements causing inaccuracies and numerical problems in simulation.

Relative permeability models currently used in commercial simulators are based on the first set of relative permeability measurements of air and water. Although the extension of Darcy's law to multiphase has some limitations, Darcy's law is a commonly used model for simulation of multiphase transport in porous media.

Multiphase transport in porous media is the result of complex momentum transfer between phase and dynamic processes, such as Haines jumps and snap-off. Core floods using reservoir rocks or artificial porous media is commonly used to study the multiphase transport in porous media. The dynamics of the multiphase transport in porous media has been studied with 2D micromodels. 3D scanning of porous media of multiphase flow in porous media can be used to measure saturation profiles or to examine pore-scale flow dynamics. Pore network models have been developed to calculate relative permeabilities as function of pore structure and phase distributions. These models rely on rules to calculate multiphase transport between pores, reducing the predictability of those models. Still, these models provide useful insights into petrophysical and fluid properties. For example, pore network models have been used to upscale reaction models.

There are numerous parameters that impact relative permeability such as wettability, pore shape and size, trapping number (interaction of viscous, gravitational, and capillary forces), saturation direction and saturation path, composition and rock surface composition, etc. The relative permeability models can be corrected ad-hoc for variations in rock and fluid properties, but these corrections can be inconsistent and do not resolve issues related to phase labeling. In addition, the number of tuning parameters can significantly increase in these ad-hoc models.

The effect of dispersed droplets and distribution of phases in porous media has been studied in various models such as hydraulic phase percolation by separating phases into percolating and non-percolating sub-phases, three sub-phases for the non-wetting phase, etc. These models, however, may not be extended to multiphase flow and may not consider ganglion dynamics.

Relative permeability curves can be a continuous function of composition, especially for applications with significant interphase mass transfer such as during a miscible gas flood. Phase equilibrium based on an equation of state (EoS) are commonly used to calculate phase compositions and saturations in compositional simulators. Those flash algorithms calculate the equilibrium compositions without labeling phases, but are then labelled for relative permeability and capillary pressure calculations. It is impossible to label phases consistently close to critical points, critical endpoints, or in supercritical regions. In addition, phase relative permeability varies significantly with compositions, and using the model based on the phase labels cannot appropriately capture such variations. Gibbs energy can be used to incorporate the effect of phase compositions on relative permeability. Gibbs energy, however, may not be a unique function of composition and may not be a practical way to resolve relative permeability inconsistencies. For example, Gibbs energy for a pure fluid does not change at constant temperature as fluid saturations change. Some previous models have used interfacial tensions to modify relative permeability models close to critical points, but relies on phase labeling. Some have used density to identify phases, but this is not a general solution to the problem.

The effect of composition and hysteresis is significantly more complex for three or more phase flow. Three-phase compositional simulations typically use approximate relative permeability models that do not fit the experimental data well. Three-phase relative permeability models can result in mixed elliptic/hyperbolic system of transport equations. Experimental studies show that three-phase relative permeability are saturation path dependent. A phase ordering technique can be used in a three-hydrocarbon mixing-cell approach, where the phases are ordered solely based on the similarity of their composition to the initial and injection compositions. However, this labeling technique may not be sufficiently robust for reservoir simulation.

A major deficiency of the above existing models is how they account for hysteresis when one phase disappears/appears because of mass transfer between the phases. Moreover, the currently available three-phase hysteresis models, by their nature, add complexity to compositional simulations. Various limitations of classical three-phase relative permeability models such as Stone I and Stone II have been identified, especially for non-water wet conditions and/or at low oil saturation. The impact of residual oil saturation in Stone I and the implied residual oil saturation by Stone II has been investigated, and it is shown that the predicted residual oil saturation values near the limiting two-phase axis are larger than measured two-phase values. Two- and three-phase residual saturations depend on wettability and saturation history. i.e. saturation direction and saturation path. In extreme wettability conditions, the wetting fluid, i.e. water or oil, shows minimal trapping and hysteresis behavior. The advancing and receding wetting films formed by imbibition and drainage processes are stable leading to a hydraulically continuous wetting phase even at very low saturations. Non-wetting phase trapping causes the wetting phase to flow in larger pores than it would otherwise have done in the absence of trapping.

Previously, ganglion size distribution and dynamics have been used to explain two-phase capillary trapping and to develop mechanistic models for capillary desaturation curves. Phase distribution and connectivity is a key parameter for multiphase transport, and the normalized Euler characteristic has been used to describe phase distribution. Furthermore, residual saturation can be related to the structure of the trapped phase by measuring in-situ specific interfacial area using CT-scanners, where similar experimental and analysis procedures can be used to measure the Euler characteristic. The purpose of the present disclosure is to develop and demonstrate the benefits of a new equation-of-state approach for calculation of relative permeability. Relative permeability is calculated as a state function, where there is only one value of relative permeability for a set of input parameters. Phase distribution and connectivity is handled through the Euler characteristic, but with a new method of normalization. The phase distribution parameter is updated in each time step along with phase wettability, saturation, and composition. In addition, the capillary number is used to adjust the relative permeability exponent and the threshold for mobilization of phases. The model is developed so that it reduces to the same form as conventional relative permeability models at appropriate limits. The present disclosure then shows how to tune the new model to typical experimental data.

Meanwhile, accurate and continuous capillary pressure (P_{c}) and relative permeability (kᵣ) models are known as key relations in modeling of enhanced oil recovery (EOR) processes. Current commercial reservoir simulators tune empirical models for relative permeabilities and capillary pressures to experimental data based solely on a limited set of data under immiscible conditions. These empirical models attempt to represent very complex compositional processes, even though they are only a function of phase saturation and type. Thus, “fully” compositional models that use these empirical relations are not fully compositional and show discontinuities in compositions and saturations result. These discontinuities may lead to failed simulations, significant inaccuracies and increased computational time.

Modeling of multiphase flow in complex geological systems is important for various engineering applications, from capillary trapping of CO₂ to oil recovery from enhanced oil recovery operations. The empirical relationship between the capillary pressure function and saturation determines the distributions of multiple immiscible phases. The relative permeability, defined as the ratio of the phase permeability and the absolute permeability, relates the decrease of flow in one phase based on saturations of all phases.

The capillary pressure is defined as the pressure difference between a non-wetting and wetting phase across a curved interface during immiscible displacement. The understanding of pore-scale fluid dynamic is required for mechanistic modeling of capillary pressure, i.e., the characterization of ganglia topology and interfacial phenomena.

Prediction of capillary pressure or relative permeability from tuned empirical models of quasi-static experiments are made as a function of saturation only, which implicitly assumes that for a given saturation a unique ganglion topology and pore structure exists at a given saturation. However, there is hysteretic behavior observed for imbibition and drainage capillary pressures owing to entrapment of the non-wetting phase following an increasing wetting phase saturation, and the difference between fluid interface area.

The hysteresis effects between drainage and imbibition Pc(S) curves can be measured using air/brine or air/mercury, and these data can be converted to reservoir conditions using both interfacial tension and contact angle information.

Recent core flooding experiments with X-ray computed tomography (CT) have augmented understanding of capillary pressure and relative permeability as CT provides direct visualization of fluid phase distributions. Direct pore-scale measurements can even visualize the interface curvatures. Estimates of capillary pressure for these in-situ ganglion have been made by measuring interfacial curvature.

Conventional Brooks-Corey empirical models for Pc or kr generally use only fluid saturation as a state variable. Continuum-scale thermodynamic models relate capillary pressure to the change in Helmholtz free energy of the system that results from a change in fluid saturation, in which it has been conjectured that a unique Pc relationship of phase saturation and interfacial area might exist under simplified assumptions.

Current relative permeability models rely on phase labeling, and cannot accurately capture the effect of compositional variations on relative permeabilities and capillary pressures in enhanced oil recovery (EOR) processes. Discontinuities in flux calculations not only cause serious convergence and stability, but also affects the estimated recovery factor.

Compositional simulation is currently based solely on empirical relationships for rock-fluid interactions, instead of on phase compositions, saturations, and phase number. The correlation-based relative permeability models are one of the main non-compositional components of reservoir simulators, even though it is known that relative permeabilities depend on phase compositions. Recent compositional extensions of relative permeability models can result in inaccurate and inconsistent results.

Another limitation of current relative permeability models is that the effect of phase topologies is not appropriately considered. Phase saturation history is used to include the effect of phase topologies. As a result, reservoir simulators can be inconsistent for simulation of enhanced oil recovery (EOR) techniques with significant mass transfer. Because of this mass transfer accurate phase labeling can be practically impossible. Furthermore, the correlation based relative permeabilities cannot model the complex compositional and hysteresis effects on relative permeabilities. Three-phase relative permeability models are usually derived from interpolation of two-phase relative permeability models. The kᵣ models are functions of saturation, composition, saturation history, wettability and capillary number. The saturation history is usually implemented considering initial-residual hysteresis models. Three-phase kᵣ models are functions of two-phase saturations, and therefore include many different saturation path possibilities.

The conventional approach is to measure relative permeabilities with immiscible phases. Next, the relative permeability curves with specific labels are generated based on whether a phase is labeled as gas or liquid for example. This phase labeling is carried forward into compositional simulation, even though mass transfer can now occur. It is clear, however, that phases approach each other at critical points, so phase labeling must become inaccurate at some point. Phase labeling not only cannot capture the compositional effect but can result in flipping of labels, which causes discontinuities in relative permeability.

The discontinuities in flux functions can be physical, for example, in heterogeneous reservoirs with different rock types or for flow reversal during hysteresis. Even with continuous flux functions, the results of compositional floods can have discontinuities, such as compositional and saturation shocks. Thus, it is difficult to solve displacements using a hyperbolic system of equations even with constant flux functions. These discontinuities can become unphysical when the relative permeability model is dependent on phase labels instead of phase composition. These unphysical discontinuities can significantly slow down the simulation by causing large changes in saturations and composition, and therefore time steps.

Gibbs energy can be used to label phases and for interpolation of the exponents and coefficients in the relative permeability models. However, this approach implicitly assumes that relative permeability is a unique function of Gibbs energy, which can violate known thermodynamic principles, since Gibbs energy for a given phase is a function of temperature, pressure and composition. Some previous models use a relative permeability model with composition dependent coefficients to fix the problem with discontinuous phase labeling. These models, however, provide an ad-hoc fix and requires a larger number of tuning coefficients. The reservoir simulators need to move from correlation-based relative permeabilities to mechanistic and predictive relative permeability models.

Hence, a continuing need exists compositional simulators for recovery predictions, particularly those that are more robust and accurate.

### SUMMARY OF THE DISCLOSURE

The key problem addressed in the present disclosure is to make compositional simulation completely robust and fully compositional in nature, and more physically predictive and accurate. Relative permeability and capillary pressure are made to be state functions, instead of based on phase labels (oil and gas) as is currently done in commercial simulators. This overcomes a significant problem, in which phase labels cause discontinuities for supercritical fluids (in composition space where labeling is not possible). Fluid in the supercritical region can be both gas like and liquid like, or in case of surfactant flooding the phase can transform from microemulsion phase to excess phases through a critical value (critical micelle concentration). Discontinuities arise from these phase labels, causing significant reductions in time-step sizes, nonconvergence of cubic equations-of-state for phase behavior estimation, inaccuracies in recovery estimates, and in many cases complete failure of the simulator. Current commercial codes, therefore, cannot practically solve complex compositional problems, and are limited to formation of two hydrocarbon phases as flow occurs. Even when they are able to solve them, the recovery estimates are highly suspect and the time for simulation can be very long, forcing many companies to perform black-oil simulation (based on more assumptions). Thus, most simulators today are not viable for compositional processes in enhanced oil recovery, such as for miscible gas flooding and chemical flooding, where three or more phases are in equilibrium.

Here is a simple illustration of the problem with relative permeability. Relative permeability is measured typically at atmospheric pressure on immiscible fluids. The phases are clearly identifiable here as gas or oil or water. The empirical relations for relative permeability are then defined based on whether a fluid is gas or oil or water. Thus, if a phase is not clearly identifiable a choice of its phase label must be made in order to determine relative permeability. If that choice is wrong, then there is a significant discontinuity in saturation (the phase saturation is now labeled as gas saturation or oil saturation for example) and in the empirical equation used to calculate relative permeability (based either on a fitted curve for gas or for oil for example). It is not possible to label phases correctly when fluids enter into the supercritical region, as phase labeling there is meaningless. Because of the phase labeling issue, a phase called gas will suddenly be transported quicker than it would be otherwise, leading to error in recovery estimates.

The present disclosure provides an equation-of-state (EoS) to model robustly and continuously the relative permeability and capillary pressure as functions of phase saturations and distributions, fluid compositions, rock surface properties, and rock structure. Absolute permeability can also be treated using the state function approach. Relative permeability is discussed primarily in this disclosure, although other petrophysical properties can be handled similarly. Phases are not labelled; instead, the phases in each grid block are ordered based on their compositional similarity. Phase compositions and rock surface properties are used to calculate wettability and contact angles. The model is tuned to measured two-phase relative permeability curves with few tuning parameters and then used to predict relative permeability away from the measured experimental data. The model is applicable to all flow in porous media processes, for example, low salinity polymer, surfactant, miscible gas and water-alternating-gas flooding, steam flooding, and other heating methods. The results show excellent ability to match measured data, and to predict observed trends in hysteresis and oil saturation trapping including those from Land's model and for a wide range in wettability. The results also show that relative permeabilities are continuous at critical points and yields a physically correct numerical solution when incorporated within a compositional simulator (PennSim). The model has very few tuning parameters, and the parameters are directly related to physical properties of rock and fluid, which can be measured. The new model also offers the potential for incorporating results from CT-scans and pore-network models to determine some input parameters for the new EoS.

The present disclosure provides a coupled equation-of-state (EoS) kᵣ-P_{c} model that can reproduce important features of the current empirical models, but also yield physically consistent predictions that generate no discontinuities. The model parameters use the same inputs for both relative permeability and capillary pressure and are tuned simultaneously. The present disclosure focuses on capillary hysteresis and understanding the components of the EoS from measured data using saturation, phase distribution (Euler characteristic or phase contact area), and wettability as inputs. The new EoS P_{c} model maintains a similar functional form as the common Brooks-Corey correlation, and can predict capillary pressure away from the tuned experimental data. The results using CT scans of imbibition and drainage processes show excellent agreement once contact angle hysteresis is included. A quadratic response surface is used to understand better the functional form of the EoS, i.e. partial derivative expressions. These derivatives are shown to be linear in saturation and phase distribution space. The new coupled kᵣ-P_{c} approach could improve compositional simulation by making it faster, more robust, and accurate since these key parameters are more continuous and physical. Computational times are significantly increased, along with robustness. Convergence in complex three-phase hydrocarbon flash calculations is significantly enhanced, paving the way for a simulator that can solve practical problems and provide improve insight into all compositional processes in the upstream oil industry.

The present disclosure further provides a fully compositional reservoir simulation based solely on continuous and robust equation-of-state (EOS) relative permeabilities. In addition, the present disclosure provides a detailed analysis of the effects of discontinuous phase labeling on simulation performance and accuracy for 1-D and 2-D water-alternating-gas flooding. The results demonstrate the significant benefits of using an EOS for relative permeabilities.

The continuity of phase compositions is very important for robustness of simulator. The role that initial K-value estimates play in flash calculation convergence cannot be ignored. For three-hydrocarbon phases, two sets of reliable K-values are provided for initial estimates. In numerical simulations, these values are usually from the previous time step and the same grid block. That approach requires small time steps even if fully-implicit methods are used. Therefore, an object of the present disclosure is to provide a fully compositional simulation model using an equation of state (EoS) for relative permeabilities to eliminate the unphysical discontinuities in flux functions caused by phase labeling. In addition, the EoS for relative permeability can be extended to three phases. The model can capture complex hysteresis effects on three-phase relative permeability. The tuned model can be then used for simulation of multi cycle water alternating gas (WAG) injection. The approach allows for a new search scheme to improve initial estimates for flash calculation. The results can show increased robustness of high-resolution compositional simulation for both front calculations (recovery estimates) and convergence of flash algorithms.

A further object of the present disclosure is to extend Implicit Pressure Explicit Composition and Euler characteristic (IMPECX) scheme to three-phase floods and to develop a new fully compositional simulator that aims to give continuity and consistency for multiphase flow in porous media for the first time. The compositional framework adopted the following criteria. First, an EoS relative permeability model is used and extended to three phases; second, the capacity of handling flash calculations for three-hydrocarbon phases is developed, and a phase association technique to avoid phase flipping across grid blocks is given. Capillary pressure is ignored here, although the same approach used to treat relative permeability could also be done for capillary pressure. Capillary pressure in the current compositional simulators also need phase labeling, which can create similar discontinuities as for relative permeability.

In accordance with an aspect of the present disclosure, a computer system for predicting petrophysical properties in a fluid having one or more phases in porous media includes a computer-readable memory; and a processor programmed to perform a sequence of steps comprising: setting an equation-of-state (EoS) for calculation of relative permeability and capillary pressure by respectively representing a change in the relative permeability and a change in the capillary pressure as a state function of a sum of changes in dimensionless parameters including phase saturations of the one or more phases and normalized Euler characteristic of the phase indicating phase connectivity; calculating block pressures; updating overall compositions based on previous time step flux; performing flash calculations to determine the phase saturations and phase compositions; finding a phase associated matrix for neighboring grid blocks and a previous time step to identify similar phases from the previous time step and between the neighboring grid blocks; updating the phase connectivity based on different wettability conditions; solving the EoS to obtain the relative permeability and the capillary pressure; and calculating fluxes of the fluid between the neighboring grid blocks based on the phase associated matrix.

In accordance with another aspect of the present disclosure, a method of operating a computer system for predicting petrophysical properties in a fluid having one or more phases in porous media includes: setting an equation-of-state (EoS) for calculation of relative permeability and capillary pressure by respectively representing a change in the relative permeability and a change in the capillary pressure as a state function of a sum of changes in dimensionless parameters including phase saturations of the one or more phases and normalized Euler characteristic of the phase indicating phase connectivity; calculating block pressures; updating overall compositions based on previous time step flux; performing flash calculations to determine the phase saturations and phase compositions; finding a phase associated matrix for neighboring grid blocks and a previous time step to identify similar phases from the previous time step and between the neighboring grid blocks; updating the phase connectivity based on different wettability conditions; solving the EoS to obtain the relative permeability and the capillary pressure; and calculating fluxes of the fluid between the neighboring grid blocks based on the phase associated matrix.

Additional advantages of the present invention will become readily apparent to those skilled in this art from the following detailed description, wherein only the preferred embodiment of the invention is shown and described, simply by way of illustration of the best mode contemplated of carrying out the invention. As will be realized, the invention is capable of other and different embodiments, and its several details are capable of modifications in various obvious respects, all without departing from the invention. Accordingly, the drawings and description are to be regarded as illustrative in nature, and not as restrictive.

### BRIEF DESCRIPTION OF THE DRAWINGS

Reference is made to the attached drawings, wherein elements having the same reference numeral designations represent similar elements throughout and wherein:

FIG. 1: The composition is used to calculate the phase wettability and interfacial tensions.

FIG. 2: Betti numbers (β₀, β₁, β₂) and Euler values (x) for simple 3D shapes.

FIG. 3: Red and gray colors represent the two phases. The ganglion have constant shape and distribution across the micromodel. (left). The ratio of χ, χₘₐₓ, χ₁₀₀% and measurement scale is 4.0 for cases 1 and 2 so that \hat{χ} remains constant. (right) Both saturation and χ are divided by 4.0 in case 3 so that \hat{χ} remains the same as the values for cases 1 and 2.

FIG. 4: Evolution of Euler characteristics with saturation as measured by CT-scan.

FIG. 5: Schematic representation of different processes in a WAG cycle for relative permeability.

FIG. 6: Distribution of oleic and aqueous phase in drainage and imbibition processes. The aqueous phase saturation is 0.67. The images are created using Matlab™ Image processing tool based on FIG. 13. The injection and production ports are at the left and right sides of the figure. χ_{100%} is −360 and χₘₐₓ is 1000.

FIG. 7: (left) The model in Table 1 is tuned to calculated Euler characteristic based on FIG. 13. (right) The relative permeability model of Eqs. (2) is tuned to relative permeability data of FIG. 11. The tuned Euler characteristic values of the left figure are used to calculate relative permeability in the right figure.

FIG. 8: (left) The model is tuned to the hysteresis data of FIG. 1. (right) Predicted relative permeability data based on the hysteresis data.

FIG. 9: A ternary diagram showing the composition path for a three-component one-dimensional compositional displacement. The composition route is simulated using PennSim at a temperature of 160° F. and 180 psia using 10 grid blocks. The route shocks into the two-phase immiscible region from the gas injection composition along the gas tie line and then moves along the binodal curve (just inside the two-phase region) close to the critical point.

FIG. 10: Relative permeabilities for phase 1 and 2 using PennSim.

FIG. 11: Euler characteristic for phase 1 and 2 using PennSim.

FIG. 12: Comparison between new mechanistic EoS model and the Brooks-Corey (BC) relative permeability model. A sudden decrease predicted from the BC model can be observed when the displacement path goes close to the critical point. This is not physical since the composition evolves continuously over the displacement process.

FIG. 13: Schematic of ternary displacements with different composition routes a and b.

FIG. 14: Phase behavior of a lumped component model of a real crude. The composition path is simulated using UTCOMP as shown in the black dashed curve. Phase densities invert along this composition path.

FIG. 15: Phase labeling based on density thresholds causes significant differences in the simulation results. The dashed line represents the threshold phase density for each case.

FIG. 16: Schematic of P_{c} versus S_{w} including drainage and imbibition hysteresis and phase distribution.

FIG. 17: Illustration of calculation the normalized non-wetting phase Euler characteristics including three cycles of imbibition and drainage (each cycle has a different color).

FIG. 18: Coupled tuning of P_{c}-kᵣ EoS model. (top) Tuned relative permeability model to the data of FIG. 25. (bottom) Tuned capillary pressure model to the data of FIG. 22.

FIG. 19: The tuned capillary pressure model for primary drainage (PD) and main imbibition (MI) capillary pressure data.

FIG. 20: The capillary pressure curve during main imbibition is predicted based on EoS P_{c} tuned in Case 1.

FIG. 21: Response surface fitting using P_{c}=P_{c}(S, \hat{χ}, I). Experimental data (points) include primary drainage, main imbibition and main drainage. Two surfaces of constant wettability are shown here (the complete response surface cannot be shown in 4D).

FIG. 22: Response surface fitting from FIG. 21, including drainage and imbibition processes.

FIG. 23 A schematic illustrates the selection of initial K-value estimates based on neighboring grid blocks for 1-D flow.

FIG. 24 Tuning of two-phase flow data.

FIG. 25 Predicted results for three-phase oil relative permeability based on the model tuned to two-phase data in FIG. 17.

FIG. 26: The composition path for WAG injection at x_{D}=0.1 and x_{D}=0.9. The saturation variation is more significant close to the injection well.

FIG. 27 Relative permeability of phases at x_{D}=0.1 for three cycle WAG injection.

FIG. 28: The saturation profiles at (left) t_{D}=0.4 and (right) 0.8 PVI, respectively. The phase order changes frequently but the trend of phase saturations is smooth. The smoothness improves at later time.

FIG. 29: The composition profiles at (left) t_{D}=0.4 and (right) 0.8 PVI, respectively. The composition variation is smooth and not affected by fluctuations in saturations.

FIG. 30: Time-step sizes based on grid pore volume injected for a 1-D three-hydrocarbon phase flood. The step sizes are near 1.0, which is the limit for stability of explicit techniques for a miscible flood.

FIG. 31: The effect of number of grid blocks on simulation results. The results with 100 grid blocks (right) are more smooth compared to the results with 50 grid blocks (left).

FIG. 32: Large grid blocks smear out the effect of discontinuity. The discontinuity in relative permeability creates an unphysical gradient in flux values. The gradient increases by resolution of simulation model.

FIG. 33: The permeability map of horizontal reservoir model.

FIG. 34: Mole fraction of CO₂ at different dimensionless times (PVI). The composition varies continuously in the reservoir model without fluctuation.

FIG. 35: The map of “second phase” saturation shows frequent fluctuation or flipping of phases. The results of the simulator, however, is not affected by these fluctuations because relative permeabilities are not determined by their phase label, but only by their compositions and phase amount.

FIG. 36: The number of phases at different times. The number of phases is continuous and shows no convergence problems associated with current simulators.

FIG. 37: Time step sizes for 2D simulations based on grid PVI. The values are close to the stability limit.

FIG. 38: Mass recovery of two heavy components.

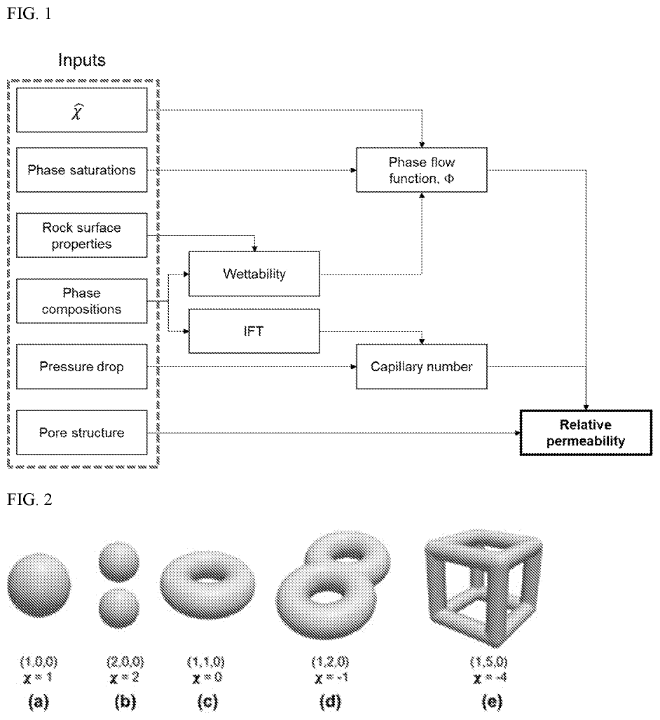

### DETAILED DESCRIPTION OF THE DISCLOSURE

The present disclosure provides an equation-of-state (EoS) to model robustly and continuously the relative permeability as functions of phase saturations and distributions, fluid compositions, rock surface properties, and rock structure. Phases are not labelled; instead, the phases in each grid block are ordered based on their compositional similarity. Phase compositions and rock surface properties are used to calculate wettability and contact angles. The model is tuned to measured two-phase relative permeability curves with few tuning parameters and then used to predict relative permeability away from the measured experimental data. The model is applicable to all flow in porous media processes, but is especially important for low salinity polymer, surfactant, miscible gas and water-alternating-gas flooding. The results show excellent ability to match measured data, and to predict observed trends in hysteresis and oil saturation trapping including those from Land's model and for a wide range in wettability. The results also show that relative permeabilities are continuous at critical points and yields a physically correct numerical solution when incorporated within a compositional simulator (PennSim). The model has very few tuning parameters, and the parameters are directly related to physical properties of rock and fluid, which can be measured. The new model also offers the potential for incorporating results from CT-scans and pore-network models to determine some input parameters for the new EoS.

According to one aspect of the present disclosure, a computer system for tuning experimental data and predicting petrophysical properties in a fluid having one or more phases in porous media, and generating a compositional simulator using the predicted petrophysical properties, can include a computer-readable memory and a processor programmed to perform a sequence of steps. These steps can include setting an equation-of-state (EoS) for calculation of any one of relative permeability, capillary pressure, and absolute permeability by respectively representing a change in the relative permeability, a change in the capillary pressure, and a change in absolute permeability as a state function of a sum of changes in dimensionless parameters including phase saturations of the one or more phases and normalized Euler characteristic of the one or more phases indicating phase connectivity; calculating block pressures; updating overall compositions based on previous time step flux; performing flash calculations to determine the phase saturations and phase compositions; finding a phase associated matrix for neighboring grid blocks and a previous time step to identify similar phases from the previous time step and between the neighboring grid blocks, wherein a grid block includes average fluid and rock properties for a considered volume of the fluid, and the phase associated matrix is an Np by Np matrix including zero or one, where the Np is the number of the one or more phases; updating the phase connectivity based on different wettability conditions, solving the EoS to obtain the relative permeability, the capillary pressure, or the absolute permeability; and calculating fluxes of the fluid between the neighboring grid blocks based on the phase associated matrix.

According to another aspect of the present disclosure, a method of operating a computer system for tuning experimental data and predicting petrophysical properties in a fluid having one or more phases in porous media, and generating a compositional simulator using the predicted petrophysical properties, can include setting an equation-of-state (EoS) for calculation of any one of relative permeability, capillary pressure, and absolute permeability by respectively representing a change in the relative permeability, a change in the capillary pressure, and a change in absolute permeability as a state function of a sum of changes in dimensionless parameters including phase saturations of the one or more phases and normalized Euler characteristic of the one or more phases indicating phase connectivity; calculating block pressures; updating overall compositions based on previous time step flux; performing flash calculations to determine the phase saturations and phase compositions; finding a phase associated matrix for neighboring grid blocks and a previous time step to identify similar phases from the previous time step and between the neighboring grid blocks, wherein a grid block includes average fluid and rock properties for a considered volume of the fluid, and the phase associated matrix is an Np by Np matrix including zero or one, where the Np is the number of the one or more phases; updating the phase connectivity based on different wettability conditions; solving the EoS to obtain the relative permeability, the capillary pressure, or the absolute permeability; and calculating fluxes of the fluid between the neighboring grid blocks based on the phase associated matrix.

Relative Permeability as an Equation of State (EoS)

Phase relative permeability is proposed in the present disclosure to be a state function, which can be determined without phase labeling or tracking the saturation history. The change in relative permeability can be represented as a function of the change in five dimension parameters as shown in Eq. (1).

$${dk}_{r} = \underbrace{\frac{\partial {k}_{r}}{\partial S} dS + \frac{\partial {k}_{r}}{\partial \tilde{x}} d \hat{ϰ}}_{Phase distribution} \overbrace{+ \frac{\partial {k}_{r}}{\partial I} dI}^{Wettability} + \underbrace{\frac{\partial {k}_{r}}{\partial {N}_{ca}} {dN}_{ca}}_{Capillary number} + \overbrace{\frac{\partial {k}_{r}}{\partial λ} dλ}^{Rock structure} \qquad ( 1 )$$

where S represents phase saturation, \hat{χ} is the normalized Euler characteristic indicating phase connectivity as discussed in the next section, I is the wettability index presented in the present disclosure, λ represents pore structure, and N_{CA} is the capillary number. The phase composition affects phase wettability (I) and capillary number (NCA), and evolution of Euler characteristic with time. The interfacial tension (IFT) and wettability models such as parachor weighted IFT for hydrocarbons and compositional wettability for low salinity water flooding can be incorporated directly to the relative permeability model as discussed in the present disclosure. Other dimensionless groups could also be added to Eq. (1), such as the gravity number (or combined with capillarity in a trapping number) or based on situ stress parameters.

According to one aspect of the present disclosure, the effect of phase distribution on relative permeability is described assuming I, λ, and N_{CA} are constant. The predicted relative permeability curves, however, are examined for different, but constant values of the wettability and capillary numbers. A change in wettability and capillary number is included in the first two partial derivatives of Eq. (1). That is, the partial derivatives in Eq. (1) are defined where all other parameters are constant, for example, ∂kᵣ/∂S is the derivative of relative permeability with saturation at constant phase connectivity, wettability, capillary number, and pore structure. Thus, the expression for ∂kᵣ/∂S can include the wettability parameter (or any of the other three parameters) similar to what is done in thermodynamics for partial derivatives. If wettability changes from one time step to the next (or spatially), however, then the value for ∂kᵣ/∂S should change, along with the separate wettability term in Eq. (1). A similar argument can be made for changing the value of ∂kᵣ/∂S with capillary number.

The proposed model should, although not required, reduce to current conventional relative permeabilities at appropriate limits. This is advantageous so that the proposed model can be easily incorporated in current simulators and applied to simpler processes such as for waterflooding. According to one aspect of the present disclosure, to ensure this limit and for the purposes of the present disclosure, Eq. (1) can be integrated, with the assumption that the ratio α_{Φ}=(∂kᵣ/∂S)/(∂kᵣ/∂\hat{χ}) is constant, along with wettability, pore structure, and capillary number. This gives the following expression used in the present disclosure for the integration of first two terms in Eq. (1).

kᵣ=Cₖ(S+α_{Φ}\hat{χ}−Φᵣ)ⁿ^{ₖ}, (2)

where Cₖ is related to the endpoint relative permeability, and nₖ is the exponent. Φᵣ is the threshold phase distribution parameter where phases becoming mobile. The exponent nₖ, Cₖ, and Φᵣ can be related to wettability, capillary number and rock pore structure.

Φ can be defined to represent the phase distribution as,

Φ=S+α_{Φ}\hat{χ}, (3)

The residual saturation can therefore be calculated as,

Sᵣ=Φᵣ−α_{Φ}\hat{χ}. (4)

There is currently limited experimental data or network modeling results to justify a more complex version of Eq. (2). The specific form of Eq. (2) could be modified as needed as future data is obtained.

Euler Characteristic

The Euler characteristic defined by Eq. (5) is used in the present disclosure to quantify the phase connectivity based on CT-scan imaging of two-phase flow in three-dimensional rock samples. Other parameters, such as contact area between phases, could also be used, but for purposes of the present disclosure only the Euler characteristic can be used. The Euler characteristic is defined as,

χ=β₀−β₁ (5)

where β₀ is the number of clusters, and β₁ is number of redundant loops or connections. The parameter β₂, which is assumed to be zero, indicates the number of enclosed voids in the fluid cluster.

FIG. 2 shows example values of Euler characteristics for simplified cases.

The Eider characteristic depends on the phase connectivity, measurement scale pore volume (PV), pore structure, and phase saturation (S). Ideally, for Eq. (1) a parameter is included to represent solely the phase connectivity. Thus, the normalization scheme in the related art is modified to eliminate most of the dependence on saturation.

The limiting values of the Euler characteristic are related to pore structure. Assuming that a completely dispersed phase would form one cluster in each pore, the maximum value (χₘₐₓ) is equal to the number of pores (a large positive value). At the other limit, when a single phase occupies the entire porous media (saturation is 1.0), the minimum value of the Euler characteristic is one minus the number of redundant pore connections (typically a large negative value labeled χ_{100%}). To reduce the effect of scale on the Euler characteristic, the characteristic should be normalized by phase volume, while its limits should be normalized by pore volume and phase saturation. This is in contrast to a normalization, which scaled the Euler characteristic based only on pore volume. Thus, the normalized Euler characteristic becomes.

$$\hat{χ} = \frac{\frac{χ}{S \times PV} - \frac{{χ}_{max}}{PV}}{\frac{{χ}_{100 \%}}{PV} - \frac{{χ}_{max}}{PV}} ,$$

which can be further simplified to

$$\hat{χ} = \frac{\frac{χ}{S} - {χ}_{max}}{{χ}_{100 \%} - {χ}_{max}} . \qquad ( 6 )$$

Other scaling equations could be used other than what is shown in Eq. (6).

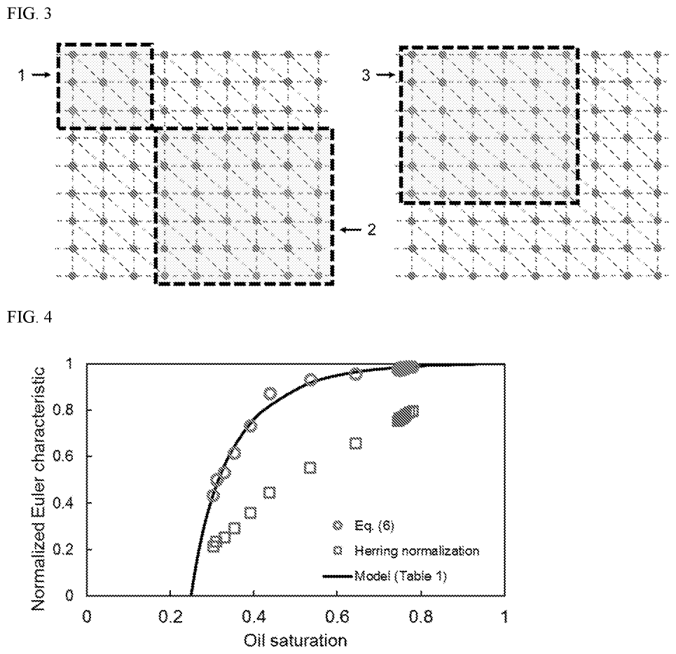

FIG. 3 demonstrates the use of Eq. (6) for an ideal phase distribution where all ganglion have the same configuration and are evenly distributed. The figure shows that the normalized Euler characteristic is only a function of ganglion topology and independent of saturation and measurement scale. FIG. 4 compares the values of \hat{χ} based on measurements for an imbibition process where inspection of their CT-scan images indicate that the oil phase remains connected as the oil saturation decreases to around 0.4 and then the oil phase starts to become discontinuous. This phenomenon is better represented by normalization using Eq. (6), red circles in FIG. 4, which remains close to 1.0 for oil saturations above 0.4 compared to the older normalization, blue squares.

FIG. 3 does not imply that connectivity is dependent on saturation. That is, there could be multiple values of connectivity for a fixed value of saturation. The figure only illustrates the connectivities for a specific case as saturation changes.

State Functions and Thermodynamic Process

The change in the normalized Euler characteristic must be calculated with time in simulation. The Euler characteristic can change with time even for constant saturation, say for a film spreading process or change in capillary number. Because saturation nearly always changes with time, the change of the Euler characteristic \hat{χ} can be defined as a function of saturation for imbibition and drainage processes. This does not contradict the assumption that these two state functions are independent, as is explained next.

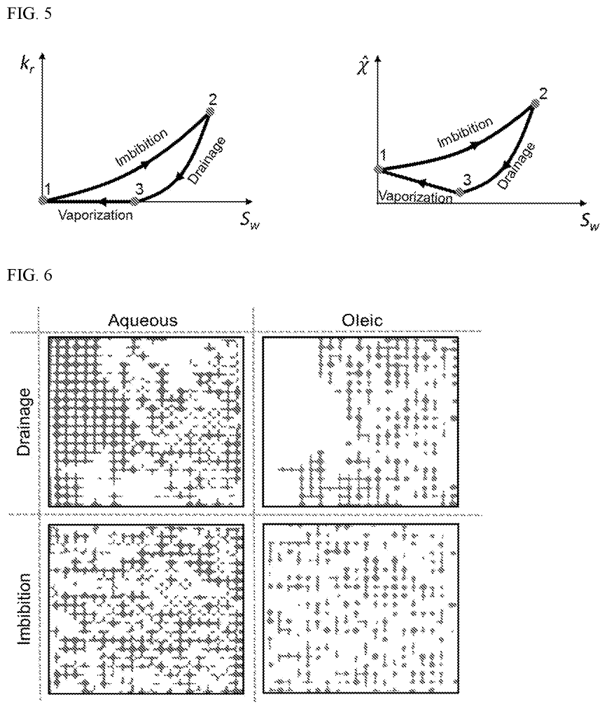

FIG. 5 shows a cycle in relative permeability. Although the processes in a relative permeability cycle are not reversible, the cycle can be considered similar to other thermodynamic cycles, for example, the Carnot cycle. In many ideal thermodynamic processes such as adiabatic processes, state functions follow a specific path where one parameter is a function of the other in that path. For example, pressure is often taken as a function of volume even though both are independent. The parameters \hat{χ} and S are similarly independent.

By taking a specific path, ∂\hat{χ}/∂S for the drainage and imbibition parts can be defined as shown in FIG. 5. The relative permeability must be the same value at the same \hat{χ} and S values. Thus, if the state is returned back to the initial state (state 1), the relative permeability is the same regardless of the path or process taken to that state. If saturation is constant, the relative permeability can only change if the Euler characteristic changes, and vice versa. Based on this reasoning,

$$\frac{d \hat{χ}}{dt} = \frac{\partial \hat{χ}}{\partial S} {\vert}_{Imbibition} \frac{dS}{dt} , \qquad ( 7 )$$

where the coefficient can be calculated as a function of capillary number, wettability, pore structure, Euler characteristic, and saturation. That is,

$$\frac{\partial \hat{χ}}{\partial S} = f ( {N}_{Ca} , I , λ , \hat{χ} , S ) . \qquad ( 8 )$$

The Evolution Function for Euler Characteristic

The proposed models for drainage and imbibition at different wettability conditions are shown in Table 1. These condition can be derived based on few constraints. Equation (6) shows that the value of \hat{χ} is 1.0 when saturation is 1.0. Therefore, when saturation increases, the value of \hat{χ} approaches 1.0 as calculated by the equation in Table 1. When phase saturation decreases, however, the phase would remain connected until some threshold value. ∂\hat{χ}/∂S can be defined for decreasing saturation such that a phase remains connected at higher saturations.

Other functions besides those in Table 1 could be used, but these are simple functions easily tuned to data. Further, the Euler characteristic of a non-wetting phase can be related linearly to saturation in the drainage process, but exponentially in an imbibition process. Thus, both values of \hat{χ} and S for a given phase must approach 1.0 as all other phases vanish. The expressions in Table 1 are not continuous in the first derivative (as a drainage process becomes an imbibition process), but data support such a reversal. It may be possible to make the function continuous if needed for smoother flux calculations in simulation. Lastly, the coefficients of the models in Table 1 must be adjusted for different wettability condition and capillary numbers.

TABLE 1
The values of ∂\hat{χ}/∂S for different wettability conditions and
displacement processes.

| | $\frac{\partial S}{\partial t} > 0$ | $\frac{\partial S}{\partial t} < 0$ |
|---|---|---|
| $\frac{\partial \hat{χ}}{\partial S}$ | ${α}_{χ} ( \frac{\hat{χ} - 1}{S - 1} )$ | $\frac{1}{{{C}_{χ} ( \hat{χ} S )}^{{n}_{χ}}}$ |

Table 1 provides expressions to complete the EOS model development so that complex hysteresis effects on relative permeability can be captured. A more comprehensive model, however, is necessary to include the effect of wettability alteration, capillary number and potentially the spreading coefficient for film drainage processes (when three phases are present). Wettability is considered next.

Effect of Wettability Alteration

Experiments show that the evolution of the phase distribution for the wetting and non-wetting phase is complex. The wettability index I as defined in the present disclosure is used to interpolate values for the change in the Euler characteristic with saturation for mixed wet conditions.

$$\frac{\partial \hat{χ}}{\partial S} = {I ( \frac{\partial \hat{χ}}{\partial S} )}_{θ = 180} + ( 1 - I ) {( \frac{\partial \hat{χ}}{\partial S} )}_{θ = 0} \qquad ( 9 )$$

Corey's Model

The hysteresis effect is ignored in Corey's model so that,

$$\frac{\partial \hat{χ}}{\partial S} {\vert}_{imbibition} = \frac{\partial \hat{χ}}{\partial S} {\vert}_{drainage} = f ( S , I ) . \qquad ( 10 )$$

Although wettability alteration is not considered in Corey's model, the relative permeability curves are different for wetting and non-wetting phases. Therefore ∂\hat{χ}/∂I is not zero and the following can be defined,

$$\frac{\partial \hat{χ}}{\partial S} {\vert}_{I} = f ( I , S ) . \qquad ( 11 )$$

Tuning Procedure

The Euler characteristics can be tuned based on 3D scanning, or hysteresis experimental data. In the calculations that follow, changes in the Euler characteristic can be considered as a function of saturation, although more formally Eq. (1) could be used. The parameters in Table 1, however, are functions of wettability and capillary number. The integration of the equations in Table 1 gives Eq. (12) for increasing saturation and Eq. (13) for decreasing saturation.

$$\begin{matrix}\hat{χ} = ( {\hat{χ}}_{0} - 1 ) {( \frac{S - 1}{{S}_{0} - 1} )}^{{α}_{z}} + 1 & ( 12 ) \\ \hat{χ} = {( \frac{n + 1}{C ( 1 - n )} ( \frac{1}{{S}^{n + 1}} - \frac{1}{{S}_{0}^{n + 1}} ) + {\hat{χ}}_{0}^{n + 1} )}^{\frac{1}{n + 1}} . & ( 13 )\end{matrix}$$

When CT-scan measurements are available, the Euler characteristics can be tuned based on image processing. The alternative approach is to use measured values of residual saturation for different initial saturation to tune the Eider characteristic model. Both methods are illustrated in the results section. Furthermore, development of analytical solutions using the new relative permeability could facilitate the tuning procedure.

IMPECX Implementation

Next, the steps for an Implicit Pressure Explicit Composition and Euler characteristic (IMPECX) simulation scheme can be explained using the new relative permeability model. Although the relative permeability model is independent of phase labeling, similar phases can be identified across a time step and between neighboring grid blocks for the numerical derivatives needed for flux calculations. This tracking is much simpler than phase labeling because the range of tracking is only one time step or one grid block, while the phase labeling must be consistent across all grid blocks for all time steps. Further, it is easy to identify the phase pairs by their compositions. The steps involved in the IMPECX scheme are as follows:
1. Solve pressure implicitly.
2. Update grid block compositions explicitly.
3. Perform flash calculations to determine phase compositions and saturations.
4. Determine similar phases from the previous time step to calculate ΔS/Δt for each phase then calculate Δ\hat{χ}/Δt based on Table 1 and update the Euler characteristic.
5. Calculate relative permeabilities.
6. Estimate fluxes at block boundaries using a flux estimation scheme such as single-point upstream weighting.

The difference in phase densities or better yet Gibbs energy differences can help to determine similarity of the phases, but this is not sufficiently robust. A better way to establish phase similarity for flux calculations is using the compositional distance between phases as shown in Eq. (14) between phase j in block 1 and phase k in block 2

$${L}_{jk} = {\sum }_{i = 1}^{{N}_{c}} {( {x}_{i}^{j , 1} - {x}_{i}^{k , 2} )}^{2} , \qquad ( 14 )$$

where xᵢ is the mole fraction of component i and N_{c} is the number of components. Tie-line space parameterization and a negative flash calculation could also make the phase tracking process more efficient, although Eq. (14) is likely all that is needed.

Some processes are always a function of the phase type, such as chemical reactions in the aqueous phase Such reactions would have to be defined based on a phase labeling scheme, although this is quite easy for an aqueous phase that consists mostly of the water component. The new EOS can retain the phase labels without any change in the procedure, however, the relative permeabilities are not a function of phase labels.

Phase Association Matrix

A phase association matrix is an Np by Np matrix, where Np is the number of phases. The matrix reorders the phases to ensure consistency in the composition matrix. i.e. the same order of phases. The association matrix is invertible and contains mostly zero elements, except for Np of them which are equal to 1.

A composition matrix is an Np by Nc matrix, where Nc is the number of components.

The association matrix is calculated based on minimizing the norm of the distance between phases,

$${min}_{A} ‖ {C}^{α} - {AC}^{β} ‖ ,$$

where C is the composition matrix, α and β are the composition matrix indexes. A is the association matrix, C^{α} and C^{β} are compositions of neighboring block or compositions of the same block at a different time. The above equation is used to estimate the solution. The matrix A is less important when phases have very similar composition.

Results

Consider next three examples of the application of the new EoS relative permeability model. In the first case, the images from micromodel experiments are used to tune the Euler characteristics, then the measured relative permeability data are used to tune the relative permeability model. The second case demonstrates the use of hysteresis data to tune the Euler characteristic model without the use of any imaging technique. The relative permeability curves are predicted for this case as well without any experimental measured relative permeability data. The third case demonstrates the implementation of the new relative permeability model in our in-house reservoir simulator, PennSim, and shows that unphysical discontinuities are eliminated.

Case 1: Euler Characteristics Tuned to Micromodel Images

Conventionally, the relative permeability in glass micromodels has been measured for different wettability conditions. The present disclosure used micromodel images and relative permeabilities for water-diesel experiments to tune the EoS relative permeability model. First, the image-processing toolbox of Matlab™ is used to calculate the phase saturations and Euler characteristics. The phase distribution results after image processing are shown in FIG. 6.

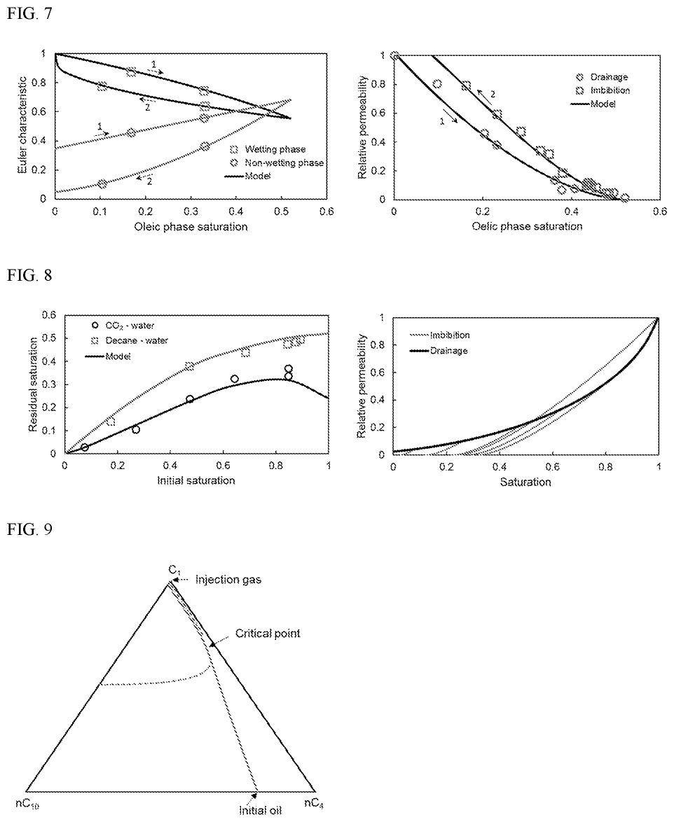

The calculated values of Euler characteristic for both wetting and nonwetting phases are shown in FIG. 7 (left). The results indicate that the wetting phase (water) remains very well connected in the drainage process while the connectivity of the nonwetting phase (diesel) increases slowly. The non-wetting phase quickly forms disconnected ganglions in the drainage phase as indicated by a smaller Euler characteristic value.

Next, the equations in Table 1 is tuned to match the value of Euler characteristic as shown in FIG. 7 (left). The tuned parameters are given in Table 2. The relative permeability model is tuned to Equation (2) for the wetting phase. The coefficient am is negative in FIG. 7 (right) and Table 2, which means in this experiment the wetting phase flows better with less connections. FIG. 6 shows that the wetting phase in the imbibition process forms a connected path across the micromodel without many redundant connections, compared to the drainage process where the wetting phase is distributed in separate small regions with many redundant connections that are less useful for displacement. It is important to emphasis that the hysteresis effect in relative permeability values of FIG. 7 (right) are captured perfectly by only one tuning parameter, α_{Φ}, where the tuning of Euler characteristic model in FIG. 7 (left) is completely independent of relative permeability data on FIG. 7 (right).

TABLE 2
The tuned parameters for the results shown in FIG. 7.

| | Euler characteristic | | | | Relative permeability | | | |
|---|---|---|---|---|---|---|---|---|
| Phase | α_{χ} | \hat{χ}₀ | C_{χ} | n_{χ} | α_{Φ} | Cₖ | Φᵣ | nₖ |
| Oleic | 0.98 | 0.35 | 0.38 | −0.29 | — | — | — | — |
| Aqueous | 0.47 | 1.00 | 1.51 | 0.49 | −0.41 | 5.11 | 0.26 | 1.51 |

Case 2: Euler Characteristic Model Tuned to Hysteresis Data

The hysteresis data is used next to tune the Euler characteristic model. Hysteresis data are easier and cheaper to measure compared to CT-scan imaging and image processing, although they give less insight. Experimentally measured residual saturation can be indicated as a function of initial saturation for CO₂—water and decane—water. First, in the present disclosure, the procedure to calculate residual saturation is explained and then the tuning procedure and results are discussed.

The residual saturation is calculated based on solving Eq. (4) where Eq. (13) is used to calculate the Euler characteristic value in Eq. (4). The value of \hat{χ}₀ in Eq. (13) is the value of the Euler characteristic at the initial saturation S₀ at the end of drainage process calculated by Eqs. (12).

The residual saturations calculated by the tuned model are shown in FIG. 8 left and the predicted relative permeabilities for CO₂—water case are shown in FIG. 8 right. The residual saturation of CO₂ decreases when the initial saturation is increased to 1.0. As a result, the relative permeability curves for the imbibition and drainage process cross. Similar trends have been observed in experimental measurements. The tuned parameters values are shown in Table 3. The values of \hat{χ}₀, α_{Φ}, Cₖ, Φᵣ and nₖ are assumed to be independent of fluid properties to further constrain the tuning process.

TABLE 3
The tuned parameters for the results shown in FIG. 8.

| | Euler characteristic | | | | Relative permeability | | | |
|---|---|---|---|---|---|---|---|---|
| Experiment | α_{χ} | \hat{χ}₀ | C_{χ} | n_{χ} | α_{Φ} | Cₖ | Φᵣ | nₖ |
| CO₂-water | 1.18 | 0.30 | 1.47 | 1.25 | 2.56 | 0.11 | 030 | 2.00 |
| Decane-water | 0.43 | 0.30 | 1.52 | 0.39 | 2.56 | 0.11 | 0.30 | 2.00 |

Case 3: Two-Phase Three-Component Miscible Flood

The three-component displacement is considered next, where a discontinuity exists in relative permeability owing to phase labeling. The phase relative permeabilities should become linear at the critical point when IFT approach zero. For simplicity, the change in wettabiity can be calculated based on the heavy component concentration as explained in the present disclosure.

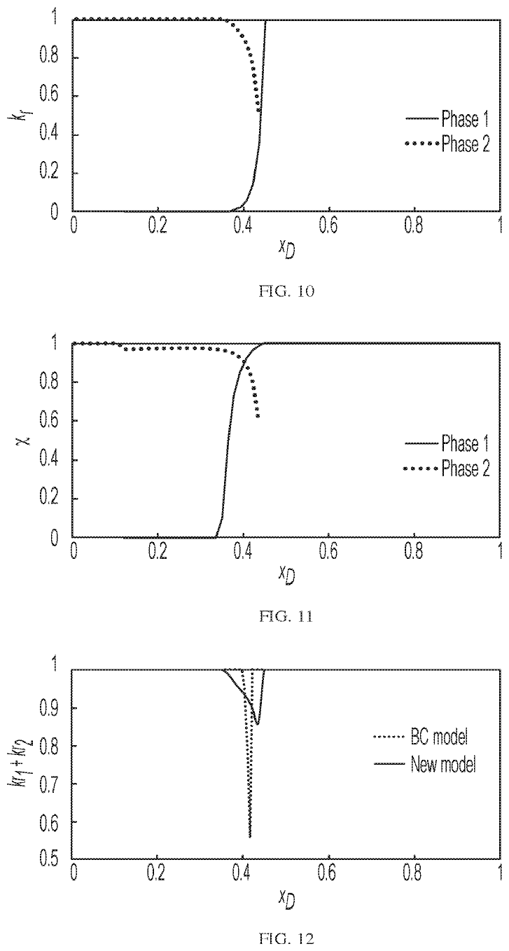

The profile of relative permeabilites and Euler characteristics are shown in FIGS. 10 and 11, which show good continuity of phases (saturations), and relative permeabilities as determined by Eq. (1). The phases in these figures can be identified as phase 1 and 2 based on their compositions. In a 2D or a 3D reservoir model, however, it is nearly impossible to make the labels continuous and the results would be erroneous.

FIG. 12 compares the sum of relative permeabilities for the two phases calculated by Brooks-Corey and our new model. The Brooks-Corey model is not adjusted for compositions and results in clearly unphysical results near the critical point at a dimensionless distance of 0.40. An unphysical result in mobility can impact the sharpness of the front, in this case making the Brooks-Corey front more sharp than our compositional model.

Conclusions

The present disclosure provides a framework for modeling relative permeabilities as a function of the phase state in porous media, where effects of wettability, hysteresis, and compositional variations are incorporated. The phase relative permeabilities are modelled to be independent of labeling and saturation paths. Furthermore, the impact of phase compositions on relative permeabilities was implemented by modelling phase wettability and interfacial tensions compositionally. In addition, the hysteresis effects on relative permeability were added by defining the phase distributions and connectivity. The model only requires a few tuning parameters and analytical solutions of the model for specific experimental conditions were constructed to tune the model parameters.

Simple models for the evolution of phase connectivity were presented that capture complex hysteresis effects as a function of phase wettability and composition. Realistic predictions of relative permeability were made based on initial-residual curves. Further, CT scan results were used to tune the new EoS model, which demonstrates its potential to connect these type of small scale measurements to field scale simulations, including those from network modeling.

The mechanistic relative permeability model was tested using a one-dimensional ternary miscible simulation within our in-house simulator (PennSim). The results from those simulations show that the new EoS model avoids the unphysical discontinuities of conventional relative permeability models. Further, it is possible to completely eliminate phase labeling from a compositional simulator even for flux calculations. This is very desirable so that relative permeability can change more physically and also to speed up simulation by avoiding unphysical discontinuities.

Phase Labeling

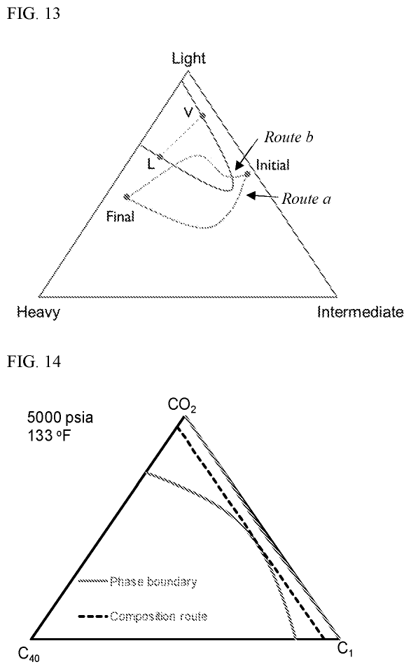

One task in modeling three phases is to define the threshold phase density to identify and label the phases since the relative permeability models depend on the phase type. It is difficult and likely impossible to keep the labeling consistent in the entire reservoir for a given displacement, and it becomes even more complex for multi-layer heterogeneous reservoirs. FIG. 13 for example shows a schematic of one-dimensional displacements undergoing different composition paths. If route b is selected, the single phase at the final state might be labeled as liquid. In contrast, if route a is selected, the single phase could be labeled as either vapor or liquid from the initial to final state. As a result, the same final state could be labeled differently depending on the route selected, even though it is the same phase composition.

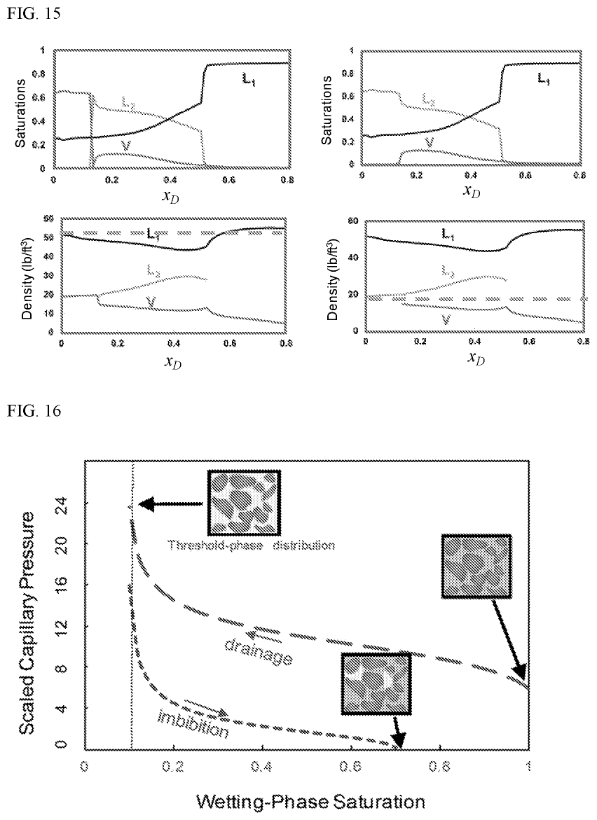

The phase behavior for a three-component case can be represented in FIG. 14 at constant pressure and temperature conditions. A trial and error technique is often applied to identify the best threshold density between the second liquid (L₂) and vapor (V) phases at relatively high pressure. Phase mislabeling could occur when the unique threshold density fails to label the phases correctly, which can cause discontinuities in the simulation results and subsequent failure as shown in FIG. 15. The corresponding saturation results are represented in FIG. 15 based on UTCOMP compositional simulation. Discontinuities and instabilities can be observed in FIG. 15. Many of these problems could be avoided if the algorithm used in simulation is independent of phase type, but no current commercial simulator has been formulated this way until now.

Wettability Index

The wettability index for each phase is defined and a series of conditions are briefly discussed to ensure the consistency and continuity in the model. Further investigation is required to develop a comprehensive model for wettability as a function of composition for different processes, but any reasonable model would make the prediction of relative permeability more realistic and continuous.

The sum of the wettability index must be 1.0. That is,

ΣIᵢ=1, (15)

Wettability is a complex function of phase compositions and rock surface properties, including rock and fluid composition and roughness. Different wettability models can be used as long as they satisfy the realistic limiting conditions. For example, the water-wet fraction for carbonates in low salinity water flooding can be defined as a function of rock surface composition. The wettability index for low salinity waterflooding in carbonates is,

$${\hat{I}}_{w} = 1 - \frac{[ > {CaOH}_{2}^{+} ( - {COO}^{-} ) ]}{[ Ca , total ]} , \qquad ( 16 )$$

The wettability of hydrocarbons is a function of the charges of fluid molecules and rock surface charges. The relationship between oil composition such as acid number and aromatic contents to the contact angle has been demonstrated in the previous studies. The acid and aromatic molecules are usually among the heaviest components in the oil. Therefore, a simple model can be used for wettability of a hydrocarbon phase based on the heavy component concentration in the ternary example given in the results section.

One more step is needed to ensure that the wettability model is consistent and continuous at phase boundaries. A phase wettability index should be 1.0 when that is the only phase present. For example, oil becomes the wetting phase in a water wet rock as water completely evaporates owing to gas injection, while the gas phase remains the non-wetting phase. This would appear to give a discontinuity in the wetting phase index. This problem can be solved by correcting the wettability for small saturations. A strongly wetting phase can form a very thin layer on the rock surface, how ever, the thickness of the film cannot become zero. Therefore, a wetting phase cannot cover all the rock surface at very small saturations, and the wettability index of a “wetting” phase should approach zero as the phase disappears. The spreading of a wetting phase on a rock surface ceases after reaching an equilibrium thickness. The calculation of the film thickness is challenging, and S_{film} is usually insignificant compared to residual saturation. Using a typical value for the sandstone specific surface area of 2×10² l/cm and porosity of 20%, S_{film}≈10⁻³ is estimated, which is significantly less than typical values of residual saturation. Therefore, saturation dependent wettabilities can be defined for saturations less than S_{film} to make the wettability model continuous with insignificant effect on relative permeability and residual saturation values.

The present disclosure further develops a coupled equation-of-state (EoS) kᵣ-P_{c} model that can reproduce important features of the current empirical models, but also yield physically consistent predictions that generate no discontinuities. The model parameters use the same inputs for both relative permeability and capillary pressure and are tuned simultaneously. The present disclosure focuses here on capillary hysteresis and understanding the components of the EoS from measured data using saturation, phase distribution (Euler characteristic or phase contact area), and wettability as inputs. The new EoS P_{c} model maintains a similar functional form as the common Brooks-Corey correlation, and can predict capillary pressure away from the tuned experimental data. The results using CT scans of imbibition and drainage processes show excellent agreement once contact angle hysteresis is included. A quadratic response surface is used to understand better the functional form of the EoS, i.e. partial derivative expressions. These derivatives are shown to be linear in saturation and phase distribution space. The new coupled kᵣ-P_{c} approach could improve compositional simulation by making it faster, more robust, and accurate since these key parameters are more continuous and physical.

Capillary Pressure as an EoS

Capillary pressure is proposed to be a state function, just as was done for relative permeability. That is,

$${dP}_{c} = \frac{\partial {P}_{c}}{\partial S} dS + \frac{\partial {P}_{c}}{\partial \hat{χ}} d \hat{χ} + \frac{\partial {P}_{c}}{\partial I} dI + \frac{\partial {P}_{c}}{\partial {N}_{CA}} {dN}_{CA} + \frac{\partial {P}_{c}}{\partial λ} d λ , \qquad ( 17 )$$

where S represents phase saturation; \hat{χ} is the normalized Euler characteristics. I is the wettability index, N_{CA} is the capillary number, and λ is the pore connectivity. The parameter \hat{χ} describes phase connectivity, the value of \hat{χ} is 1.0 when saturation is 1.0 (fully-connected), but decreases to zero when fully disconnected. As shown in FIG. 16, it is unlikely to achieve zero, however, as when phase saturation decreases, the phase would remain connected until some threshold value \hat{χ}₀. More state variables could be added to Eq. (17) if necessary, but it is assumed here that these five variables describe capillary pressure changes fully and that for every set of the input state variables there is only one value of capillary pressure.

Larger N_{CA} leads increased phase connectivity and therefore higher relative permeabilities would be anticipated. Static capillary pressure experiments are commonly conducted at very small flow rate and small N_{CA}. λ represented pore structure, which is used in capillary pressure scaling, generally by taking the form λ=\sqrt{k/φ}, where k is the absolute permeability, and φ is the porosity.

In the present disclosure, both the effect of phase distribution and wettability on capillary pressure can be examined, assuming N_{CA} and λ are constant. That is,

$${dP}_{c} = \frac{\partial {P}_{c}}{\partial S} {\vert}_{\hat{χ} , I} dS + \frac{\partial {P}_{c}}{\partial \hat{χ}} {\vert}_{S , I} d \hat{χ} + \frac{\partial {P}_{c}}{\partial I} {\vert}_{\hat{χ} , S} dI . \qquad ( 18 )$$

The derivatives in Eq. (18) can contain both capillary number and pore connectivity, but they must be constant during the experiments. The wettability index I can take many forms, but here it can be represented solely by the contact angle θ, where its value is taken to be a constant during drainage and imbibition. Thus,

I=cos θ. 19)

An alternative approach would be to use the interfacial area between the various phases instead of the normalized Euler characteristic. The development that follows would be similar, where \hat{χ} is replaced by the contact area.

In the present disclosure, the following model is proposed so that it is similar in form to the empirical model of Brooks-Corey,

$${P}_{c} = {{P}_{c , e} ( {Φ}_{w} - {Φ}_{w , r} )}^{- \frac{1}{λ}} , \qquad ( 20 )$$

where P_{c,e} can represent capillary entry pressure during primary drainage, or it can be related to the state condition where the flow direction reverses. The form of Eq. (20) is used here only for convenience and could be changed in the future if warranted from experimental data, i.e. if the exact form of the derivatives in Eq. (18) are known. Equation (20) assumes the derivatives are proportional to each other.

P_{c,e} in Eq. (20) is dependent on the rock-pore structure (λ), wettability or contact angle (θ), and more importantly, phase connectivity. One reason for using phase connectivity (Euler characteristic) is that for the non-wetting phase (\hat{χ}ₙ) connectivity is less affected by experimental noise than the wetting phase. P_{c,i} is a tuning parameter based on interfacial tension and contact angle with the same unit as P_{c,e} as shown in Eq. (21).

$${P}_{c , e} = {{P}_{c , i} ( {\hat{χ}}_{n} )}^{\frac{1}{λ}} = {P}_{i} cos {θ ( {\hat{χ}}_{n} )}^{\frac{1}{λ}} . \qquad ( 21 )$$

The effective wetting-phase connectivity (Φ_{w}) can be defined as shown in Eq. (22). Besides the wetting-phase saturation, Φ_{w}, also includes the pseudo-wetting phase connectivity. This pseudo-wetting phase connectivity represents the fraction of trapped non-wetting phase throughout the pore space that does not contribute to capillary pressure. β is a dimensionless timing parameter for phase connectivity. That is,

Φ_{w}=S_{w}+(1−S_{w})(1−\hat{χ}ₙ)^{β}. (22)

Furthermore, Φ_{w,r} in Eq. (20) is the threshold wetting phase distribution parameter where the wetting-phase becomes mobile. Similarly, the threshold phase distribution parameter r was also included in the calculation of relative permeability as a state function as,

kᵣ=Cₖ(S+α_{Φ}\hat{χ}−Φᵣ)ⁿ^{ₖ}, (23)

where Cₖ is related to the endpoint relative permeability (but can vary here), and nₖ is the exponent. The effect of phase distribution on relative permeability can be shown, assuming I, N_{CA}, and λ are constant.

Tuning Procedure for Coupled P_{c}-kᵣ EoS

Capillary pressure is closely related physically to relative permeability. Therefore, consistency between physical features such as hysteresis is an important feature in applied P_{c}-kᵣ models. A specific path and corresponding model of the evolution of the normalized Euler characteristic with saturation can be shown in Table 4. Any path could have been used to compute state values of capillary pressure (or relative permeability), but the experiments take a specific path. Once the parameters are tuned, the relations in Table 4 completes the required equations for the coupled P_{c}-kᵣ EoS model to fit experimental data and predict capillary pressure.

TABLE 4
Relations for the path of ∂\hat{χ}/∂S for different wettability condition and
displacement process.

| | $\frac{\partial S}{\partial t} > 0$ | $\frac{\partial S}{\partial t} < 0$ |
|---|---|---|
| $\frac{\partial \hat{χ}}{\partial S}$ | ${α}_{χ} \frac{\hat{χ} - 1}{S - 1}$ | $\frac{1}{{{C}_{χ} ( \hat{χ} S )}^{{n}_{χ}}}$ |

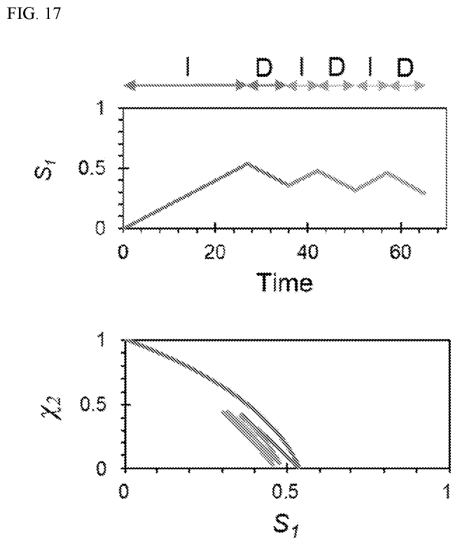

After inputting the change of saturation (increasing or decreasing), the integration of the relations in Table 4 give the values of the normalized Euler characteristics for both the wetting and non-wetting phases. For example, FIG. 17 illustrates the calculation of non-wetting phase Euler characteristics during three cycles of imbibition and drainage. Then, the parameters P_{c,i}, β, Φ_{w,r}, and λ are tuned for the calculations of capillary pressure, while the parameters α_{Φ}, Cₖ, Φᵣ, nₖ are tuned for the relative permeabilities. Therefore, P_{c} and kᵣ are tuned and predicted consistently based on the same values of phase saturation, connectivity, and contact angle. For simplicity, the contact angle can be only for capillary pressure.

Pc Response Surface

The above equations assumed a specific form of the state functions. It would be better however to understand how the partial derivatives in Eq. (17) vary as a function of all input parameters. To begin to understand these relations a simple quadratic response surface can be proposed to fit experimental data where

P_{c}=f(S_{w},\hat{χ}_{nw},I). (24)

The P_{c} response surface is taken to be a second-order polynomial function.

P_{c}(S,\hat{χ},I)=β₀+β₁S+β₂\hat{χ}+β₃I+β₁₂S\hat{χ}+β₁₃SI+β₂₃\hat{χ}I+β₁₁S²+β₂₂\hat{χ}₂+β₃₃I². (25)

The partial derivatives (slope with all other parameters constant) can be calculated from Eq. (25). The accuracy of these slopes depend on the density of data near the derivative point. The sign of the slope indicates how certain state variables impact capillary pressure, while the magnitude gives its relative importance (if normalized).

Results

Four examples can be considered to illustrate the new state function EoS for capillary pressure coupled with the relative permeability model. Case 4 illustrates tuning of both capillary pressure and relative permeability simultaneously. For the second case (Case 5), primary drainage and imbibition capillary pressure hysteresis data are used to tune the Euler-characteristic model and capillary pressure model. In the third case (Case 6), the primary drainage capillary pressure curve is predicted using the P_{c} EoS model and compared to measured data (based on the tuning from Case 5). The results of modeling P_{c} using a quadratic response surface is also presented.

Case 4: Coupled Tuning of P_{c}-kᵣ Model.

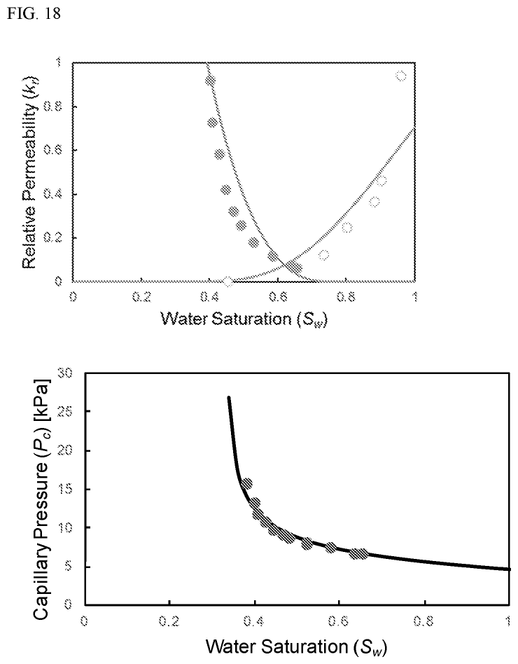

The new coupled P_{c}-kᵣ EoS is tuned simultaneously to the set of experimental data in FIG. 18. The values of the tuned parameters are given in Table 5. Capillary pressure and relative permeability drainage curves for non-wetting phases were simultaneously measured on a Berea Sandstone core using scCO₂ and brine as fluid pair, and the relative permeability drainage curve for wetting phase can be obtained.

TABLE 5
The tuned parameters for the results shown in FIG. 18.

| | | | | | | | | | Capillary | | | |
|---|---|---|---|---|---|---|---|---|---|---|---|---|
| | Euler | | | | Relative | | | | pressure[kPa] | | | |
| | characteristic | | | | permeability | | | | P_{c,i} | | | |
| Phase | α_{χ} | \hat{χ}₀ | C_{χ} | n_{χ} | α_{Φ} | Cₖ | Φᵣ | nₖ | [kPa] | β | Φ_{w,r} | λ |
| Non- | 1.18 | 0.4 | 1.47 | 1.25 | 0.2 | 12.0 | 0.3 | 2.5 | 5.2 | 1.1 | 0.42 | 2.6 |
| wetting | | | | | | | | | | | | |
| Wetting | 0.43 | 0.4 | 1.52 | 0.39 | 0.42 | 5.0 | 0.22 | 3.6 | — | — | — | — |

Case 5: P_{c} Model Tuned to Hysteresis Data.

Capillary pressure including a cycle of primary drainage (PD and main imbibition (MI) can be measured at very small flow rates. Sintered soda lime beads were used that gives a matrix similar to a strongly water-wet sandstone both in terms of pore-size distribution and long-range connectivity of the wetting fluid. Brine was used as the wetting fluid and n-dodecane as the nonwetting fluid.

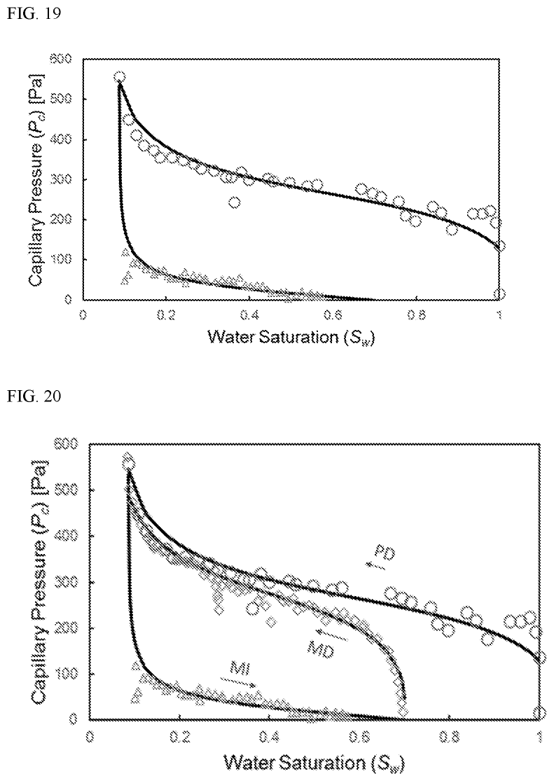

FIG. 19 shows the comparison between tuned capillary pressure curve (lines) and experimental measurements during primary drainage (round points) and main imbibition (triangle points) with the tuned coefficients given in Table 6. The value for P_{c,i} is different during primary drainage and main imbibition due to the effect of contact angle hysteresis. The fits are excellent. The data is not matched well if contact angle hysteresis is neglected.

TABLE 6
The tuned parameters for the results show in FIG. 19
for Euler characteristics and capillary pressure curves
during primary drainage (PD) and main imbibition (MI).

| | Euler | | | | P_{c} (PD)[Pa] | | | | P_{c} (MI)[Pa] | | | |
|---|---|---|---|---|---|---|---|---|---|---|---|---|
| | characteristic | | | | P_{c,i} | | | | P_{c,i} | | | |
| Phase | α_{χ} | \hat{χ}₀ | C_{χ} | n_{χ} | [Pa] | β | Φ_{w,r} | λ | [Pa] | β | Φ_{w,r} | λ |
| Non- | 2.7 | 0.1 | 1.04 | 0.5 | 265.0 | 0.34 | 0.05 | 3.10 | 35.0 | 0.34 | 0.05 | 0.82 |
| wetting | | | | | | | | | | | | |

Case 6: Prediction Using EoS P_{c} Model.

The EoS P_{c} tuned in Case 5 is further used to predict capillary pressure data away from the tuned experimental data as shown in FIG. 20. The prediction of capillary pressures during main drainage using EoS P is validated based on experimental data in FIG. 19. The agreement is excellent.

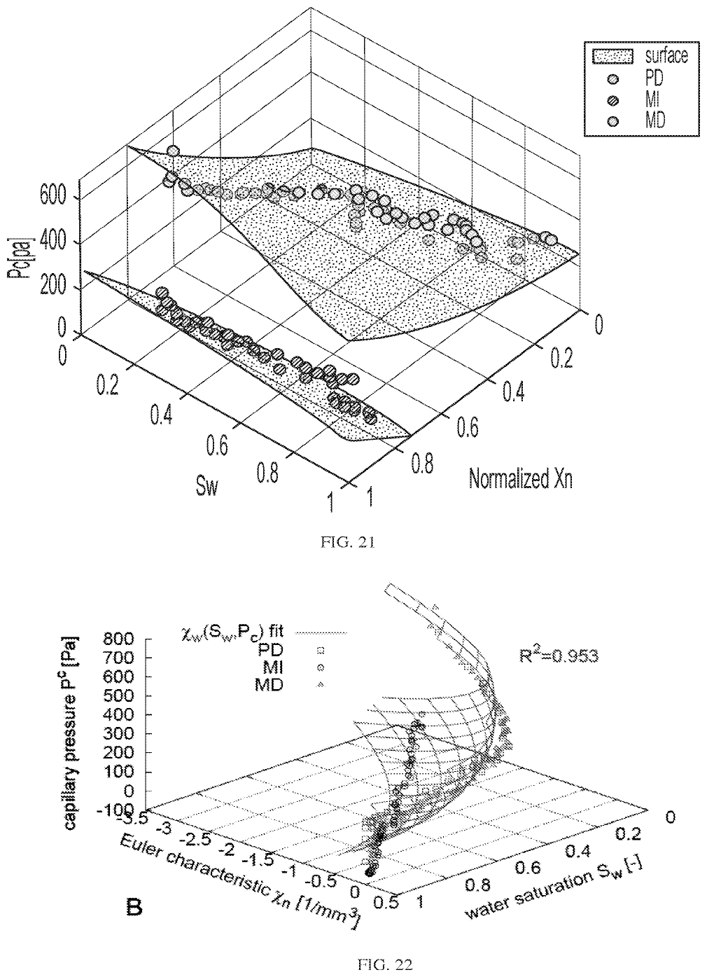

The fitted response surface in Eq. (25) versus the experimental data is shown in FIG. 21. The R² error is 0.974 from fitting the P_{c} response surface after introducing contact angle hysteresis as compared to 0.834 when using only S and \hat{χ}. The polynomial fitting is shown in the present disclosure, using χ_{w}=f(S_{w}, P_{c}), which was not able to match the data well.

Conclusions

Capillary pressure can be modelled as a continuous function of the phase saturation, connectivity, and wettability. A new expression (EoS) for capillary pressure is derived that is directly coupled with relative permeability. A simple functional form is proposed that requires only a few tuning parameters. The effect of capillary pressure hysteresis is incorporated. It is shown that the new model can be used to predict capillary pressure away from the tuned experimental data and the agreement is excellent for example data set. The new coupled P_{c}-kᵣ EoS can be tuned simultaneously based on the same set of inputs. For the first time, it is demonstrated that capillary pressure is a state function like relative permeability, and that both can be determined as a function of the same set of input phase saturations and distributions. The results using experimental data from CT scans of imbibition and drainage processes show that capillary pressure is a state function and can be fit well with a quadratic response surface.

A response surface can be fitted through experimental data assuming,

χ_{w}=f(S_{w},P_{c}). (26)

Based on their fitting, for some sets of (χ_{w}, S_{w}), there are two values of P_{c} as shown in FIG. 22. Thus, it is not a state function. A state function is obtained by making the Euler characteristic a function of wettability (contact angle hysteresis).

The present disclosure further provides a novel way forward to develop a fully compositional reservoir simulation based solely on continuous and robust equation-of-state (EOS) relative permeabilities. In addition, the present disclosure provides a detailed analysis of the effects of discontinuous phase labeling on simulation performance and accuracy for 1-D and 2-D water-alternating-gas flooding. The results demonstrate the significant benefits of using an EOS for relative permeabilities.

Extension of EoS Relative Permeability to Three Phases

Two sets of coefficients can be used for the wetting and non-wetting phases. The wettability of each phase is calculated based on its composition. The model for wettability is case dependent and currently there is no general compositional model for wettability. Then, the EOS coefficients for relative permeability are calculated by linear interpolation based on wettability of each phase

kᵣ=Cₖ(S+α_{Φ}\hat{χ}−Φᵣ)ⁿ^{ₖ}, (27)

where kᵣ is relative permeability, S is saturation, Φᵣ is the threshold for phase trapping and Cₖ, α_{Φ} and nₖ are coefficients. These coefficients can be a function of other parameters, such as capillary number. The dimensionless Euler characteristic \hat{χ} represents the connectivity of a phase and is defined as

$$\hat{χ} = \frac{\frac{χ}{S} - {χ}_{max}}{{χ}_{100 \%} - {χ}_{max}} . \qquad ( 28 )$$

It is assumed that the Euler characteristic changes as a function of saturation. For typical reservoir processes, this assumption is reasonable. Phase topology can vary at constant saturation due to ganglion dynamics or phase spreading. The IMPECX scheme can consider variation of Euler characteristic independent of saturation. The evolution of Euler characteristic with saturation, however, is calculated based on the equations in Table 7, which is the equivalent of assuming a path in X-S space. Parameters in those functions are then tuned to measured data based on the wettability of the phase.

TABLE 7
Evolution of Euler characteristic as a function of saturation (Khorsandi
at al. 2017).

| | $\frac{\partial S}{\partial t} > 0$ | $\frac{\partial S}{\partial t} < 0$ |
|---|---|---|
| $\frac{\partial \hat{χ}}{\partial S}$ | ${α}_{χ} ( \frac{\hat{χ} - 1}{S - 1} )$ | $\frac{1}{{{C}_{χ} ( \hat{χ} S )}^{{n}_{χ}}}$ |

For example, the coefficients of the model are calculated here based on the wettability of the phase using,

γⱼ=Iⱼγ_{w}−(1−Iⱼ)γ_{nw}, j=1,2,3. (29)

where γ is one of the coefficients of the kr-EOS, I is wettability index, j is the phase index, w is wetting phase and nw is the non-wetting phase. As shown in the results section, the model tuned to two-phase data can closely predict three-phase relative permeability for the case considered. The predictability of the model for three phases requires further testing with more three-phase experimental data and different wetting states. In the present disclosure, residual saturation of the intermediate wetting phase increases when both wetting and non-wetting phase are present.

Phase Association

The phases must be locally associated to each other, but not labeled as a specific vapor or liquid phase. The span of this association depends on the flux scheme estimator. The following can be provided to make the association significantly easier and robust:

Lⱼₖ=Σᵢ₌₁^{N}^{_{c}}(xᵢ^{j,1}−xᵢ^{k,2})²

where Lⱼₖ is the compositional distance from one phase to another. Phases from one grid block to another, therefore, are associated by minimizing the compositional distance.

IMPECX Flow Chart

Flash Calculation

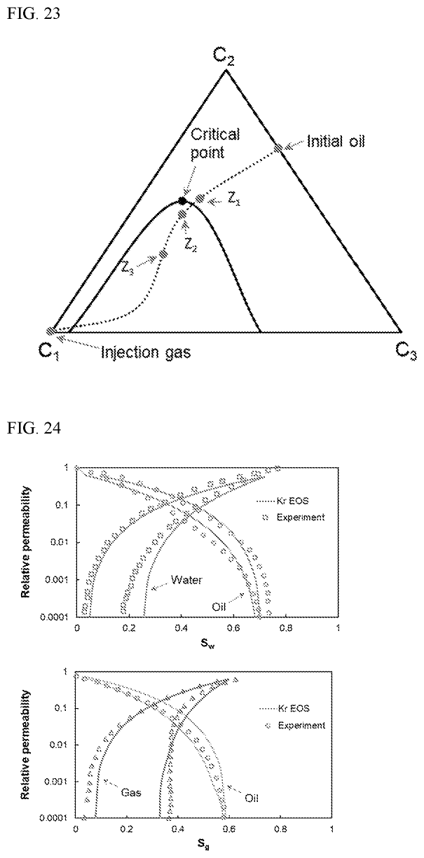

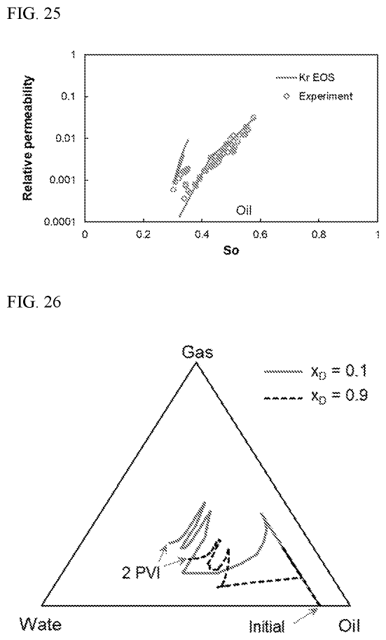

As a pre-requisite for the robustness of a compositional simulator, initial K-value estimates for both stability analysis and flash calculation must be selected carefully. Failure to provide reliable initial estimates could result in trivial solutions, especially when three-hydrocarbon phases might co-exist. Trivial solutions or inability to converge to the lowest Gibbs energy state (with the correct phase number) can generate discontinuities. In this section, a practical approach for the selection of initial estimates can be illustrated based on both the previous time step and the neighboring grid blocks that contain the maximum number of phases. If there are multiple grid blocks all containing the same maximum number of phases, the closest grid block can be selected by comparing the compositional distances. The approach is illustrated here. In FIG. 23, the hypothetical overall composition of three grid blocks in 1-D flow, namely 1, 2, and 3, are shown as red dots. The flash result of overall composition in grid block 3 provides a better initial estimate for flash calculation of composition 2, even though the compositional distance of 2 and 1 is less than the distance of 3 and 2.

Results

The compositional EoS relative permeability model can be tested for two different phase behavior models. Case 7 presents one-dimensional simulation results for water-alternating-gas injection into an oil reservoir. Three immiscible phases are considered. Case 8 demonstrates the robustness of the simulator by considering near-miscible three-hydrocarbon-phase flood in one dimension. Case 9 further shows the simulation results in two dimensions for the complex phase behavior in Case 8.

Tuning of the Model

FIG. 24 shows the tuned fits using the kr-EOS model to the two-phase data considered. The match is good using the parameters in Table 8. The saturation path is then used to calculate the relative permeability as shown in FIG. 3. These are predicted results because they were not used in the tuning process.

TABLE 8
Coefficients of Kr EOS tuned to two-phase data.

| α_{χ} | \hat{χ}₀ | C_{χ} | n_{χ} | α_{Φ} | Cₖ | Φᵣ | nₖ |
|---|---|---|---|---|---|---|---|
| 1.5 | 0.1 | 0.65 | −0.24 | 0.6 | 0.1 | 0.28 | 2.5 |
| 1 | 0.1 | 0.25 | −0.24 | 1.5 | 0.4 | 0.3 | 2 |

Wettability Coefficients

| | Water | Oil | Gas |
|---|---|---|---|
| Wettability coefficient | 0.6 | 0.4 | 0.0 |

Case 7: WAG Injection.

The tuned kr EOS is used for simulation of 1D WAG injection. FIG. 26 shows the variation in the saturation for the initial condition shown. The residual oil saturation is approached at 2 pore-volumes injected (PVI).

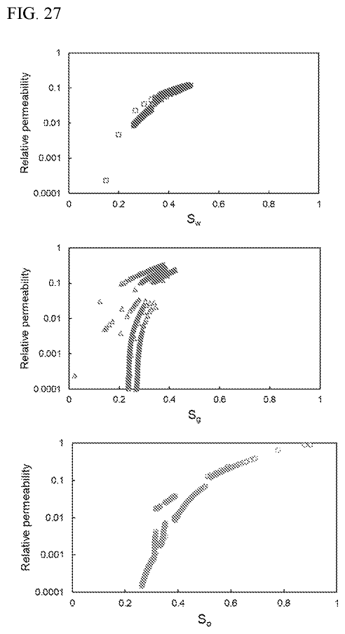

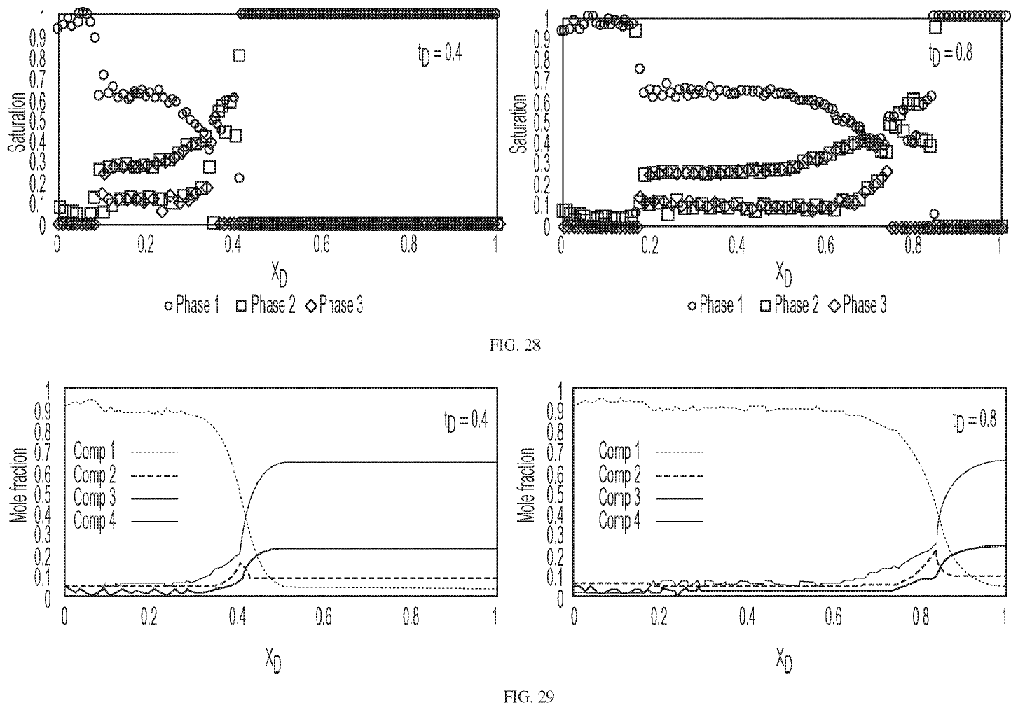

The variation of relative permeability of phases at x_{D}=0.1 is shown in FIG. 27. The water phase shows almost no hysteresis effect, while the gas phase is affected significantly by hysteresis. The oil phase relative permeability slightly increases as a small oil bank passes through and the oil phase becomes more connected.

Next, an immiscible fluid phase behavior can be used to test the consistency of extension of the EoS relative permeability to three phases.

Case 8: 1-D Three-Hydrocarbon-Phase Displacement

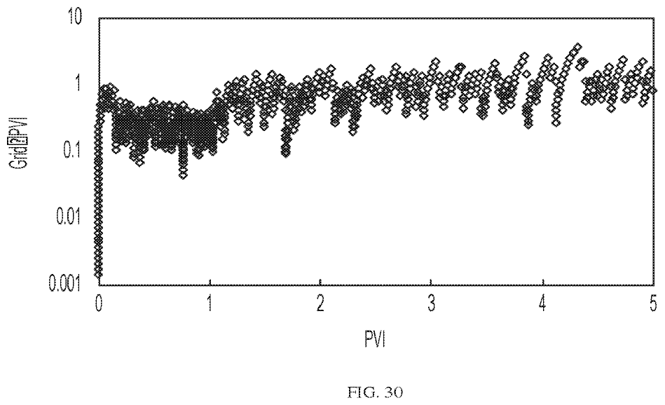

The compositional simulation involving three-hydrocarbon phases is challenging mainly owing to phase labeling issues and flash calculations. In this example, it is shown that the simulator results are continuous and smooth therefore the cut in time-step sizes is not required. As a result, the simulation can be performed very fast at their stability limits. FIG. 29 shows the phase saturations, where these are arbitrarily identified by “1”, “2”, and “3”, depending on how they occur in the cubic root finding routine inside the flash calculation. These saturation assignments are random, because the roots during a flash can switch. No assignment related to vapor-like, or liquid-like is made. Because the phase assignments are arbitrary, the saturations can exhibit fluctuations. No attempt was made here to arrange them in a continuous manner, as these assignments are not physical and do not impact the relative permeability values, which are dependent only on the phase compositions and amounts.

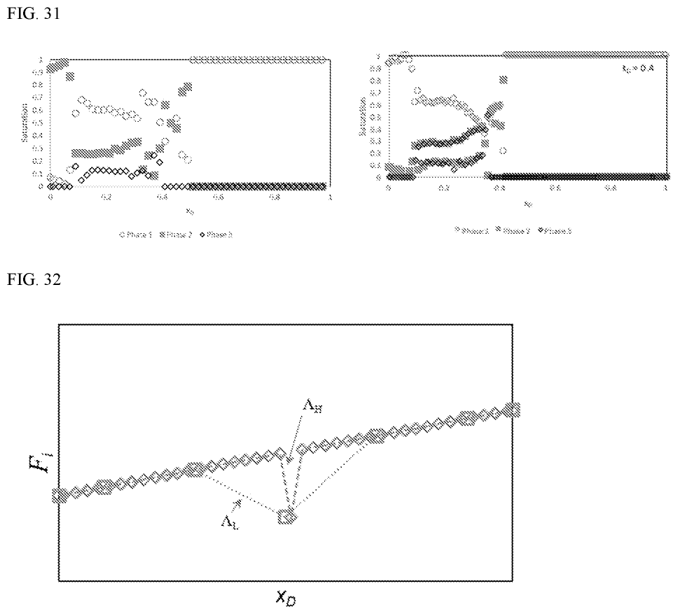

FIG. 31 shows the time-step sizes for the 1D simulation cases. The grid blocks have the same size therefore the time step sizes are represented as a fraction of the grid block pore volume injected. A time-step size of 1.0 PVI therefore means that the time-step size corresponds to a volume injected equal to one grid block volume. This is the limit for stability. That is, the explicit integration of composition become unstable when the fastest front passes through more than one grid block at one time-step. FIG. 31 shows that the simulator uses time steps close to the stability limit without the need for reductions in the time-step size, which often occurs in current composition simulators as the result of phase labeling problems.

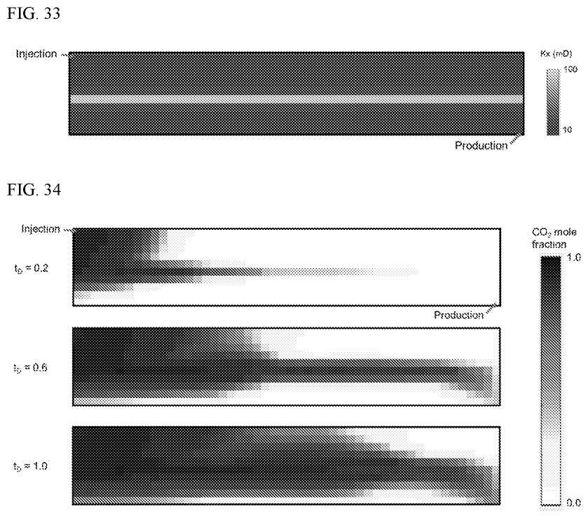

High-resolution simulation, however, is more sensitive to discontinuities in flow-rock interactions, such as relative permeability. As shown in FIG. 33, larger grid blocks smear out the discontinuities by reducing the gradient of flow properties. Therefore, compositionally consistent relative permeability models are more important for higher resolution simulations, which in turn gives improved accuracy in capturing heterogeneity.

The stability limit for explicit composition techniques is dependent on the fastest moving front in the reservoir. The compositional front velocities are a function of eigenvalues and the derivatives of flux functions affect the eigenvalues. As a result, a discontinuity can give very large eigenvalues and cause instability in simulation.

Case 9: Three-Hydrocarbon-Phase Displacement in Heterogeneous 2-D Reservoir Model.

The simulation of near miscible three-phase floods in a heterogeneous reservoir is more challenging because the fronts can move with different velocities in different regions of the reservoir. The fluid model used here is the same as for Case 8, but the reservoir is now 2-D. A thief zone of large permeability exists within the model, and permeability is highly correlated. Wells are open and vertical and placed as shown.

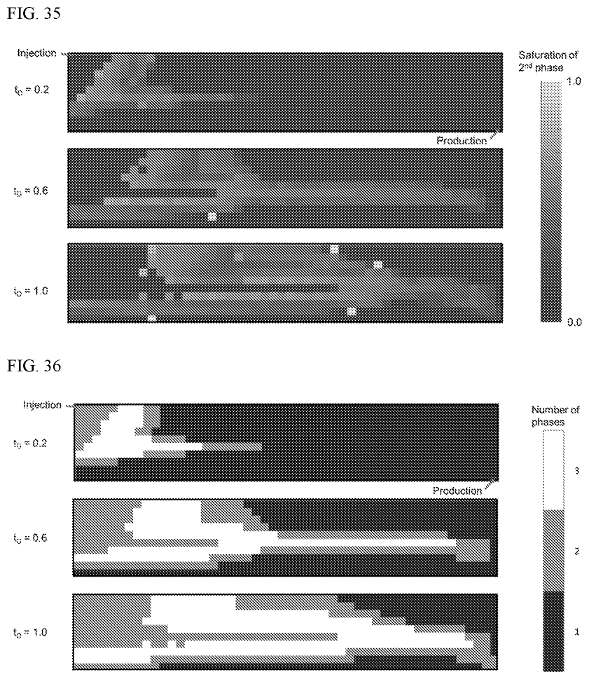

The map of CO₂ mole fraction, as shown in following diagram, exhibit a smooth variation of compositions. The map of phase saturations shows some fluctuation for an arbitrarily defined second phase in FIG. 35.

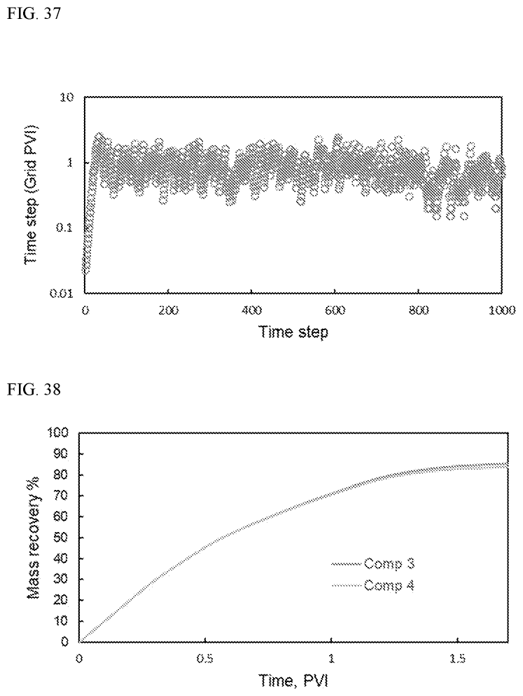

The number of stable phases for each grid block is shown in FIG. 37. The results show distinctive regions of three- and two-phase flow, where the number of phases is continuous. That is the simulation technique is robust and does not result in more random-like fluctuation in the number of phases, which indicates non-convergence of the flash calculations. See Okuno et al. for comparison, which does careful compositional simulation using a robust EoS, but still exhibits phase number flipping. This illustrates that making relative permeability smooth and consistent in the reservoir improved the convergence of flash calculations. This is likely the result of improved initial estimates.

The time-step sizes for the 2-D simulations are shown in FIG. 38. As shown, the time-step sizes are consistently large and no reduction in time step sizes are required. Furthermore, the recovery curves are also very smooth, which is another indication of stability in the simulations.

Conclusions

A fully compositional simulator using an EoS for relative permeabilities is developed. The simulator framework is successfully tested for complex miscible flooding process involving three-hydrocarbon phases, including hysteresis. The robustness and accuracy of the simulator are significantly improved using the new EoS relative permeability, especially at near-critical regions. Phase assignments are no longer needed because they do not impact the relative permeabilities, compositions, and recoveries.

The spatial resolution sensitivity of the simulator to discontinuities can be determined by comparing the new EoS relative permeability model to the relative permeability model commonly used today (Brooks-Corey model). Results showed that higher efficiency is achievable using the EoS kᵣ model even at higher resolutions. The co-existence of multiple phases requires using a large number of grid blocks, while increasing the nonlinearity of flow in the reservoir.

The new approach shown here for the first time resolves many of the problems observed in compositional simulators of today. That is, time-step sizes are near the stability limit for IMPEC, discontinuities in phase number are reduced and convergence in the flash calculations are improved owing to better initial estimates. Owing to its increased robustness and accuracy, this fundamentally new approach could solve some of the most difficult problems today, including for four-phase CO₂ miscible flooding in West Texas.

The method for developing a compositional simulator according to an embodiment of the present invention can be tangibly implemented in a non-transitory computer readable recording medium that stores a program of instructions executable by a computer, a processor, etc. The non-transitory computer readable recording medium can include each of program instructions, data files and data structures, or a combination of the ones above.

The program of instructions that are written in the non-transitory computer readable recording medium can be specially designed and configured for the present invention, or can be those available, which are generally understood by those of ordinary skill in the field of computer software. The non-transitory computer readable recording medium can be, for example, a hard disk, floppy disk, magnetic media such as magnetic tape, CD-ROM, optical media such as DVD, magneto-optical media such as a floptical disk and hardware device such as a ROM. RAM and flash memory, which are configured to store and perform the program of instructions. In addition to the above, the non-transitory computer readable recording medium can be a program of instructions and a ray of light including a carrier wave that sends a signal specifying the data structure, or can be a transmission medium such as a metal line and waveguide Examples of the program of instructions can include a machine code, such as those created by a compiler, as well as a high-level language code executable by the computer using an interpreter.

The hardware device mentioned above can be configured to work as one or more of software modules to perform algorithms of the present invention.

What is claimed is:

1. A computer system for tuning experimental data and predicting petrophysical properties in a fluid having one or more phases in porous media, and generating a compositional simulator using the predicted petrophysical properties, comprising:
a computer-readable memory; and
a processor programmed to perform a sequence of steps comprising:
setting an equation-of-state (EoS) for calculation of any one of relative permeability, capillary pressure, and absolute permeability by respectively representing a change in the relative permeability, a change in the capillary pressure, and a change in absolute permeability as a state function of a sum of changes in dimensionless parameters including phase saturations of the one or more phases and normalized Euler characteristic of the one or more phases indicating phase connectivity;
calculating block pressures;
updating overall compositions based on previous time step flux;
performing flash calculations to determine the phase saturations and phase compositions;
finding a phase associated matrix for neighboring grid blocks and a previous time step to identify similar phases from the previous time step and between the neighboring grid blocks, wherein a grid block includes average fluid and rock properties for a considered volume of the fluid, and the phase associated matrix is an Np by Np matrix including zero or one, where the Np is the number of the one or more phases;
updating the phase connectivity based on different wettability conditions;
solving the EoS to obtain the relative permeability, the capillary pressure, or the absolute permeability; and
calculating fluxes of the fluid between the neighboring grid blocks based on the phase associated matrix.

2. The computer system of claim 1, wherein the dimensionless parameters further include a wettability index of the one or more phases, a capillary number, and a pore structure.

3. The computer system of claim 2, wherein the wettability index of the phase is a complex function of compositions of phase and rock surface properties.

4. The computer system of claim 1, wherein the set EoS for calculation of the relative permeability, the capillary pressure, or the absolute permeability is independent of phase labeling and saturation paths.

5. The computer system of claim 1, wherein in the step of setting the EoS, an Euler characteristic, which depends on the phase connectivity, a pore structure including pore volume, and phase saturation is normalized by the pore volume and the phase saturation to eliminate dependence of the phase saturation.

6. The computer system of claim 1, wherein the normalized Euler characteristic of the one or more phases is tuned based on 3D scanning or hysteresis experimental data.

7. A method of operating a computer system for tuning experimental data and predicting petrophysical properties in a fluid having one or more phases in porous media, and generating a compositional simulator using the predicted petrophysical properties, comprising steps of:
setting an equation-of-state (EoS) for calculation of any one of relative permeability, capillary pressure, and absolute permeability by respectively representing a change in the relative permeability, a change in the capillary pressure, and a change in absolute permeability as a state function of a sum of changes in dimensionless parameters including phase saturations of the one or more phases and normalized Euler characteristic of the one or more phases indicating phase connectivity;
calculating block pressures;
updating overall compositions based on previous time step flux;
performing flash calculations to determine the phase saturations and phase compositions;
finding a phase associated matrix for neighboring grid blocks and a previous time step to identify similar phases from the previous time step and between the neighboring grid blocks, wherein a grid block includes average fluid and rock properties for a considered volume of the fluid, and the phase associated matrix is an Np by Np matrix including zero or one, where the Np is the number of the one or more phases;
updating the phase connectivity based on different wettability conditions;
solving the EoS to obtain the relative permeability, the capillary pressure, or the absolute permeability; and
calculate fluxes of the fluid between the neighboring grid blocks based on the phase associated matrix.

8. The method of claim 7, wherein the dimensionless parameters further include a wettability index of the one or more phases, a capillary number, and a pore structure.

9. The method of claim 8, wherein the wettability index of the one or more phases is a complex function of compositions of phase and rock surface properties.

10. The method of claim 7, wherein the set EoS for calculation of the relative permeability, the capillary pressure, or the absolute permeability is independent of phase labeling and saturation paths.

11. The method of claim 7, wherein in the step of setting the EoS, an Euler characteristic, which depends on the phase connectivity, a pore structure including pore volume, and phase saturation is normalized by the pore volume and the phase saturation to eliminate dependence of the phase saturation.

12. The method of claim 7, wherein the normalized Euler characteristic of the one or more phases is tuned based on 3D scanning or hysteresis experimental data.
